(19) United States
(12) Patent Application Publication
(10) Pub. No.: US 2014/0229116 A1
(43) Pub. Date: Aug. 14, 2014

(54) Method and System for Non-linear Quantification of Pathway Deregulation for Analysis of Malignancies

(71) Applicant: YEDA RESEARCH AND DEVELOPMENT CO. LTD., Rehovot (IL)

(72) Inventors: Eytan DOMANY, Rehovot (IL); Michal SHEFFER, Rehovot (IL); Shlomo URBACH, Rehovot (IL); Yotam DRIER, Rehovot (IL)

(73) Assignee: YEDA RESEARCH AND DEVELOPMENT CO. LTD., Rehovot (IL)

(21) Appl. No.: 14/180,374

(22) Filed: Feb. 14, 2014

Related U.S. Application Data
(60) Provisional application No. 61/764,604, filed on Feb. 14, 2013.

(51) Int. Cl. G06F 19/24

(52) U.S. Cl. CPC G06F 19/24
USPC 702/19

(57) ABSTRACT

A system and method for non-linear quantification of pathway deregulation in an individual biological sample for analysis of malignancies.

### FIELD OF THE INVENTION

The present invention is of a method and system for non-linear quantification of pathway deregulation for analysis of malignancies, and in particular of such a method and system for characterizing malignancies and tumor behavior, including with regard to the extent of pathway deregulation for a particular tumor.

### BACKGROUND OF THE INVENTION

The operation of many important pathways is altered during cancer initiation and progression. Identifying the involved pathways and quantifying their deregulation may improve understanding of the malignant process¹⁻⁵. Moreover, since advanced therapies target specific pathways, pathway-level understanding is a key step for developing personalized cancer treatments. Indeed, many methods (e.g.⁵⁻¹⁴) were developed for pathway analysis of high throughput (mainly expression) data. Nearly all methods analyze pathway activity in a global manner, on the basis of an entire sample set, and do not attempt to characterize individual tumors. One prominent exception is PARADIGM¹⁵, a powerful tool which deduces an integrated pathway activity (IPA) from mRNA expression and DNA copy number data, for each sample, on the basis of known pathway structure. However, PARDAGIM cannot analyze well complex pathways when either detailed knowledge of the mechanism of pathway activity or essential relevant data (such as protein abundance and phosphorylation) is unavailable, which is the case for a vast majority of existing cancer datasets.

### SUMMARY OF THE INVENTION

The present invention, in at least some embodiments, is of a method and system for non-linear quantification of pathway deregulation for analysis of malignancies. According to at least some embodiments, the method and system are suitable for characterizing malignancies and tumor behavior, optionally and preferably including with regard to the extent of pathway deregulation for a particular tumor.

According to at least some embodiments of the present invention, no detailed knowledge of the network or mechanism of the pathway activity is needed. Preferably, deregulation levels of many complex pathways are estimated, generating a pathway-level representation of every sample. Such a representation is demonstrated below to be clinically relevant for some exemplary, illustrative non-limiting examples of cancers, and to generate novel stratifications and outcome predictors for these cancers, for which data is shown for glioblastoma and colon cancer, specifically on three colorectal cancer datasets and two glioblastoma multiforme datasets.

According to at least some embodiments, the method comprises inferring pathway deregulation scores for each tumor sample on the basis of expression data. This score is determined, in a context-specific manner, for every particular data set and type of cancer that is being investigated. The algorithm transforms gene level information into pathway level information, generating a compact and biologically relevant representation of each sample.

According to at least some embodiments, there are provided specific pathways that are demonstrated below to be significantly associated with survival of glioblastoma patients, and two, CXCR3-mediated signaling and oxidative phosphorylation, whose scores are predictive of survival in colorectal cancer.

According to at least some embodiments, there are provided specific cancer sub-classes, including but not limited to a sub-class of each of Proneural and Neural glioblastoma with significantly better survival, and a new class of EGFR-deregulated colon cancers.

According to at least some embodiments of the present invention, there is provided a method for non-linear quantification of pathway deregulation for analysis of a malignancy, comprising selecting a plurality of biological pathways P for a malignancy; for each pathway P, identifying d_{P} genes that belong to it; determining expression values for each of said d_{P} genes, wherein each sample i of a plurality of samples is represented by a point Xᵢ of the expression values of said genes, said plurality of samples comprising malignant and normal tissue samples; calculating a Principal Curve of the cloud of points formed by the full sample set of the expression values of said genes, projecting every point onto said Principal Curve, denoting by Y, the projection of Xᵢ onto said curve. Optionally, the method further comprises determining, for each pathway P, the center of mass of the points that represent all the available normal tissue samples; and determining quantification of pathway deregulation for each individual malignant sample by comparing said center of mass of the normal tissue to said point representing every one of the malignant samples.

Optionally, said comparing said center of mass of the normal tissue to said malignant sample comprises calculating said center of mass of the normal tissue, its projection, N, onto said Principal Curve of the cloud of points formed by the full sample set of the expression values of said genes, projecting every point Xᵢ onto said Principal Curve, for each of the normal and malignant samples; determining the distance of the projection, Yᵢ from N, measured along the principal curve, wherein said distance is Dᵢ (P), the Deregulation Score of pathway P in sample i; and determining, for every sample from said plurality of samples, a plurality of deregulation scores for said plurality of pathways P.

Optionally, the method further comprises clustering, on the basis of said plurality of deregulation scores, the said plurality of samples and said plurality of pathways P.

Optionally the method further comprises determining a class or subclass for said malignancy according to said clustering of the samples.

### BRIEF DESCRIPTION OF THE DRAWINGS

FIGS. 1A and 1B—The principal curve learned for the apoptosis KEGG pathway on the Sheffer et al. colorectal dataset. The data points (representing samples of different tissue types) and the principal curve are projected onto the three leading principal components. A. The principal curve (in blue) going through the cloud of samples. The arrow indicates the direction of the curve. B. The samples projected onto the curve.

FIGS. 2A, 2B, 2C and 2D—A. Clustered normalized PDS of the TCGA GBM dataset. Each row corresponds to a pathway and each column—to a sample. Pathways and samples are clustered according to pathway scores. Blue color represents low score (“no deregulation”), and red high. The bottom bar represents the glioblastoma subtype. Notice that the pathway based clustering captures the subtypes well, and identifies a secondary sub-stratification. B. Summary of clustered PDS for the TCGA (left) and REMBRANDT (right) glioblastoma datasets. Each row corresponds to a pathway cluster and each column to a sample cluster, displaying the median value of deregulation for each pair of clusters. Arrows connect between pathway clusters that match (that is, the pathways in the clusters have significant overlap). When several matches are significant (as for ReP9 and ReP10) all are shown in dashed arrows, except for the extremely significant ones (p<10⁻⁵). Some of the Neurals/Proneurals are mostly not deregulated, and some are deregulated on TgP1/TgP2/TgP3 or matching ReP1/ReP2/ReP7. Classical tumors are deregulated on TgP4/TgP5 and possibly TgP6/TgP7 as well as matching ReP10 (and unmatched ReP6/ReP7). Mesenchymal samples are highly deregulated on TgP8-TgP16 as well as matching ReP10/ReP9/ReP8/ReP3/ReP4 (and unmatchable ReP5). The Classical-Mesenchymal cluster TgS4 matches Re58, and indeed they are both deregulated on the matching TgP4/TgP5/TgP10/TgP11/TgP12/TgP14/TgP15 and matching ReP10/ReP9/ReP8/ReP3 (as well as unmatchable ReP5). C. Normalized PDS of 94 pathways correlated with mutations. The bottom bars display the mutation status, each bar for one gene (samples with mutation are marked in black). Cluster 51 corresponds to normal samples, S2 mostly to samples with IDH1 mutations, S4 mostly to samples with NF1 mutations, and S5 mostly to samples with EGFR mutations. Notice pathway cluster P2, which consist mostly of EGF activated pathways, and is highly deregulated on the EGFR mutated samples. D. Normalized PDS of the REMBRANDT GBM dataset. As in panel A, the pathway clusters correspond to the known subtypes but offer additional sub-stratifications.

FIGS. 3A, 3B and 3C—Kaplan Meier plots of Neural and Proneural sub-stratification. A. In the TCGA dataset, patients in clusters TgS13 and TgS15 have better prognosis. Neural and Proneural tumors were divided to three groups—those in cluster TgS12 (in blue), those in TgS13 (in purple), those in TgS15 (in red) and all others (in green). Kaplan-Meier plots show clear separation between the four, where cluster TgS15 patients survive the longest (p=0.009) and cluster TgS13 little less, but still better compared to the others (p=0.015), and those in TgS12 significantly survive less than the others (p=0.003). The prognosis of the other Neural and Proneural tumors (not in TgS12, TgS13 or TgS15, in green) is similar to Classical and Mesenchymal tumors (yellow). B. In the REMBRANDT dataset, ReS2 patients have better survival. Neural and Proneural tumors were divided into two groups—those in cluster ReS2 (in red), and all others (in green). Kaplan-Meier plots show clearly better survival of the ReS2 patients (p=0.066). C. In the REMBRANDT dataset, ReS1 patients survive less. Cluster ReS1 contains only normal samples and normal-like Neural samples. Interestingly, these Neural tumors (in red) have significantly worse prognosis (p=0.032) than other Neurals (in green).

FIGS. 4A, 4B, 4C and 4D—A. Clustered normalized PDS of the Sheffer dataset. Each row corresponds to a pathway and each column—to a sample. Pathways and samples are clustered according to pathway scores. For most pathways the PDS of the normal samples is minimal (dark blue), and hence the higher the PDS is the more deregulated the pathway is. For a few pathways (mostly in ShP2) the PDS of normal samples is around zero (green-blue), and hence both highly positive PDS (dark red) and highly negative PDS (dark blue) correspond to pathway deregulation, but in different directions. The color bars at the bottom correspond to the subtype of the tumor (normal, polyp, primary and metastasis), the MSI status (normal, low high, MSS and unknown), p53 mutation status (normal, mutant, wild type and unknown), anatomic location of the tumor (normal, proximal, distal and unknown) and the CIN index (equally distributed into 20 bins). B. Summary of clustered pathway scores for the Sheffer dataset. Each row corresponds to a pathway cluster and each column to a sample cluster, displaying the median value of deregulation for each pair of clusters. The colorbar indicates the major groups of samples (normal, polyps, low CIN, EGF, high CIN and metastasis). C. Oxidative phosphorylation pathway is associated with survival. Kaplan-Meier plots for groups defined by the deregulation scores of oxidative phosphorylation in the Sheffer dataset. The primary tumor samples were divided into three equal groups, based on their level of deregulation (high, medium and low). Low deregulation scores are associated with better prognosis. D. CXCR3 pathway is associated with survival. Kaplan Meier plots for the deregulation scores of CXCR3 pathway in the Sheffer dataset. The primary tumor samples were divided into three equal groups, based on their level of deregulation (high, medium and low). High deregulation scores are associated with better prognosis.

FIGS. 5A and 5B—A. PARADIGM's IPAs for the TCGA GBM dataset. Each row corresponds to a PARADIGM “entity” and each column to a sample. Entities (pathways, interactions, complexes etc.) and samples are clustered according to the IPAs. Blue color represents low activity, and red high activity. The bottom bar displays the subtype. B. PARADIGM's IPAs correlated with mutations. The bottom bars display the mutation status for the corresponding gene.

FIG. 6—Expression of genes belonging to the immune pathway cluster ShP2. The upper panel shows the PDS of cluster ShP2. As the PDS of the normal samples is around zero (green-blue), highly positive PDS (dark red) and highly negative PDS (dark blue) correspond to pathway deregulation, but in different directions. The lower panel shows the expression of genes that participate in at least a quarter of the pathways in ShP2: each row represent a gene, blue corresponds to low expressions and red to high expressions. The color bars at the bottom correspond to the tissue type of the tumor (normal, polyp, tumor and metastasis) and the CIN index (equally distributed into 10 bins). These genes are related to lymphocytes, and may represent TILs (tumor infiltrating lymphocytes). Note that positive PDS co-occur with low expression (mostly in metastatic samples and in some of the polyps), while negative PDS correlate with high expression (mostly found among the tumors with low CIN).

FIGS. 7A, 7B and 7C—A. Clustering analysis of all the PDS in the Sveen dataset. Each row corresponds to a pathway and each column to a sample. Pathways and samples are clustered according to PDS. For most pathways the PDS of the normal samples is minimal (dark blue), and hence the higher the PDS is the more deregulated the pathway is. For a few pathways (mostly in SvP4) the PDS of normal samples is around zero (green-blue), and hence highly positive PDS (dark red) and highly negative PDS (dark blue) both correspond to pathway deregulation, but in different directions. The color bars at the bottom correspond to the MSI status of the tumor (normal, low high, MSS and unknown) and the CIN index (equally distributed into 10 bins). B. Oxidative phosphorylation pathway is associated with survival. Kaplan-Meier plots for the deregulation scores of oxidative phosphorylation in the Sveen dataset. The primary tumor samples were divided into three equal groups, based on their level of deregulation (high, medium and low). Low deregulation scores are associated with better prognosis. C. CXCR3 pathway is associated with survival. High deregulation scores are associated with better prognosis.

FIG. 8—Clustering analysis of all the PDS in the Kogo dataset. Each row corresponds to a pathway and each column—to a sample. Pathways and samples are clustered according to PDS. For most pathways the PDS of the normal samples is minimal (dark blue), and hence the higher the PDS is the more deregulated the pathway is. For a few pathways (mostly in KoP1) the PDS of normal samples is around zero (green-blue), and hence highly positive PDS (dark red) and highly negative PDS (dark blue) both correspond to pathway deregulation, but in different directions. The color bars at the bottom correspond to the tissue type of the tumor (normal, tumors) and the CIN index (equally distributed into 10 bins).

FIG. 9—Summary of recurrent clusters in the colorectal datasets (A. Sheffer, B. Sveen, C. Kogo). Each row corresponds to a pathway cluster and each column to a sample cluster, displaying the median value of deregulation for each pair of clusters. These four pathway clusters were reproduced in all three datasets. In the first row are pathway clusters for which the PDS of the normal samples is minimal around zero (cyan), and hence highly positive PDS (dark red) and highly negative PDS (dark blue) both correspond to pathway deregulation, but in different directions. For all other clusters the PDS of the normal samples is minimal (dark blue), and hence the higher the PDS is the more deregulated the pathway is. Arrows connect between pathway clusters that match (that is, the pathways in the clusters significant overlap).

FIG. 10—Hastie and Stuetzle's principal curve for simulated noisy trajectory. After 20 iterations the algorithm converges to the (wrong) curve shown in brown. The initial guess (first principal component) is shown in red. t=0 points are in green.

FIG. 11—Hastie and Stuetzle's principal curve for simulated noisy trajectory, with an educated initial guess. The initial starting curve (in red) reflects external knowledge and goes through the centers of the points labeled as t=0 (in green) and t=1. After 15 iterations the algorithm converges to the (wrong) purple curve.

FIG. 12—Modified semi-supervised principal curve for simulated noisy trajectory. After 10 iterations the algorithm converges to the curve shown in dark blue, capturing the real trajectory. The initial guess (first principal component) is shown in red. t=0 points are shown in green.

FIG. 13—Modified semi-supervised principal curve for simulated noisy trajectory. After 20 iterations the algorithm converges to the curve shown in brown, capturing the real trajectory. The initial guess (line that goes through the center of t=0 and t=1 points) is shown in red. t=0 points are shown in green.

FIGS. 14A, 14B and 14C—Finding an optimal a for the simulated data. A. The total distance to the curve as a function of a. B. The correlation between the curve parameter and the given ranking. C. The two standardized terms (correlation is negated for easier view) and their difference. For any a>0.28 the correct curve is captured and therefore the correlation is high, while for a<0.2 a curve similar to the Hastie and Stuetzle's principal curve is captured. The minimum is achieved for α=0.36 (marked by pink star). The correlation term makes sure that a>0.28 is selected and the distance term ensures that the selected a will not be too high and disturb the curve too much.

FIGS. 15-1 and 15-2—Pathways whose deregulation corresponds to point mutation of selected genes (TCGA GBM data). Pathways are ordered and numbered as in FIG. 2C.

FIGS. 16-1, 16-2, 16-3 and 16-4—Pathways whose deregulation correlates with necrosis levels (TCGA GBM data). Significance measures and Spearman correlation coefficient (denoted by p) are included.

FIG. 17—Pathways predicting survival in both glioblastoma datasets. Significant agreement was found between the pathways that predict survival. Pathways were identified by logrank p-value, with FDR (false discovery rate)<10% for each dataset.

FIGS. 18-1 and 18-2—Pathways whose deregulation scores significantly differentiate between all subsequent stages of progression (normal, polyp, primary tumor and metastasis, in that order) in the Sheffer dataset.

FIGS. 19-1 and 19-2—Pathways whose deregulation scores have significant positive correlation with the CIN index, in all three colorectal datasets (Sheffer, Sveen and Kogo). The Spearman correlation coefficient (denoted by p), p-value and Benjamini-Hochberg false discovery rate (FDR) of each are all listed.

FIGS. 20-1, 20-2 and 20-3—List of pathways that show significant differential deregulation between MSI-high and microsatellite stable (MSS) in Sheffer dataset. Specifically, these pathways were more deregulated in MSS than in MSI-high tumor samples. The significance of a subset of these pathways that were differentially deregulated in Sveen are detailed as well (the p-value of the significance is listed).

FIGS. 21-1 and 21-2—Lists of pathways that are more deregulated in MSI-high than in MS tumor samples in the Sheffer dataset. The significance of a subset of these pathways that were differentially deregulated in Sveen are detailed as well (the p-value of the significance is listed).

FIGS. 22A and 22B present the PDS values for Agilent (FIG. 22A) and Affymetrix (FIG. 22B).

FIGS. 23A and 23B show the Pearson correlations between Agilent and Affymetrix PDS values.

FIGS. 24A and 24B present a summary of clustered PDS for Agilent (FIG. 24A) and Affymetrix (FIG. 24B).

### DESCRIPTION OF AT LEAST SOME EMBODIMENTS

According to at least some embodiments, there is provided a method and system for non-linear quantification of pathway deregulation for analysis of malignancies. According to at least some embodiments, the method and system are suitable for characterizing malignancies and tumor behavior, optionally and preferably including with regard to the extent of pathway deregulation for a particular tumor.

According to at least some embodiments of the present invention, there is provided a method for non-linear quantification of pathway deregulation for analysis of a malignancy, comprising selecting a plurality of biological pathways P for a malignancy; for each pathway P, identifying d_{P} genes that belong to it; determining expression values for each of said d_{P} genes, wherein each sample i of a plurality of samples is represented by a point Xᵢ of the expression values of said genes, said plurality of samples comprising malignant and normal tissue samples; calculating a Principal Curve of the cloud of points formed by the full sample set of the expression values of said genes, projecting every point onto said Principal Curve, denoting by Y, the projection of Xᵢ onto said curve.

Optionally, the method further comprises determining, for each pathway P, the center of mass of the points that represent all the available normal tissue samples; and determining quantification of pathway deregulation for each individual malignant sample by comparing said center of mass of the normal tissue to said point representing every one of the malignant samples.

Optionally, said comparing said center of mass of the normal tissue to said malignant sample comprises calculating said center of mass of the normal tissue, its projection, N, onto said Principal Curve of the cloud of points formed by the full sample set of the expression values of said genes, projecting every point Xᵢ onto said Principal Curve, for each of the normal and malignant samples; determining the distance of the projection, Yᵢ from N, measured along the principal curve, wherein said distance is Dᵢ (P), the Deregulation Score of pathway P in sample i; and determining, for every sample from said plurality of samples, a plurality of deregulation scores for said plurality of pathways P.

Optionally, the method further comprises clustering, on the basis of said plurality of deregulation scores, the said plurality of samples and the said plurality of pathways P.

Optionally the method further comprises determining a class or subclass for said malignancy according to said clustering of the samples.

### Example 1

### Detailed, Illustrative, Exemplary, Non-Limiting Method for Determining an Extent of Pathway Deregulation

Scoring a Gene Set

According to at least some embodiments, the above described method may optionally be performed as follows. Denote by S_{P} the d_{P}-dimensional space, where each coordinate is the expression level of a gene that belongs to a given pathway P, and represent each sample by a point in this space. Determine a one-dimensional curve in S_{P} (or in a subspace of S_{P}) that best describes the variability (e.g., due to disease progression) of the samples across S_{P}. That is, a curve that passes through the “middle of the cloud” of samples is found, and it is assumed that any two points (samples) that have proximal projections onto the curve, also share similar pathway functionality.

Variance Stabilization:

Since for some genes one can observe large variation of expression, while for others a similar effect on a pathway's functionality may be induced by a smaller variation, the absolute expression values are not used. Rather, a gene's expression values are divided by the standard deviation of its expression in some normalization set of samples (such as normal samples, or the entire set of samples). To avoid genes whose entire variation is due to noise, optionally and preferably genes with little variation within all samples (normal and malignant) are omitted.

Correlations:

Many of the genes in the gene set of a pathway might be highly correlated, conveying the same information, while some other important information might reside in a single gene in the set. To counter this effect, and to improve the running time, a curve is preferably not searched in S_{P}, but in a space S_{P}′ of smaller dimensionality k, identified as follows. First optionally and preferably PCA is performed, followed by selecting only the principal components with high variance (for this Example the threshold was 1.1, i.e. keeping PC along which the variance exceeds by more than 10% that of the normalization set). The number of such PCs is k and they define the space S_{P}′, in which the entire ensuing computation is done.

Principal Curve:

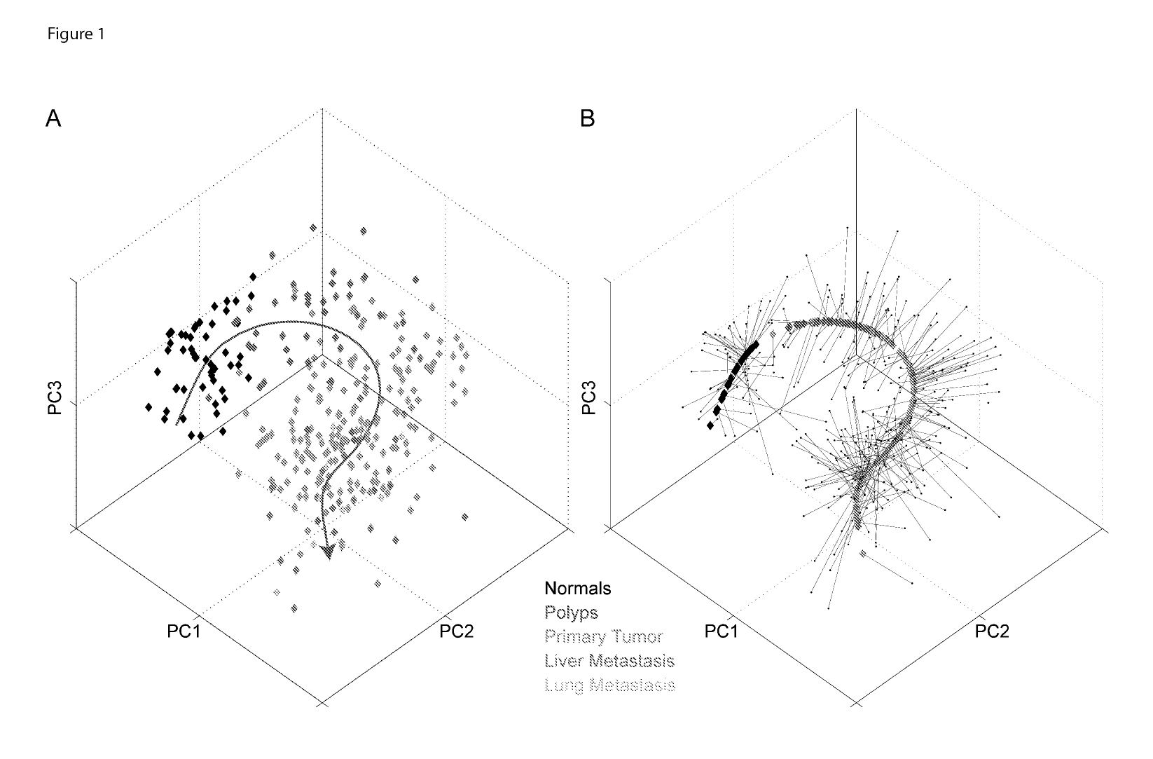

Hastie and Stuetzle's algorithm²⁰ was used to find a principal curve in S_{P}′ (see FIG. 1). For this section, it should be noted that slightly different notation was used: xᵢ (lower case, italic) is used in this section, versus Xᵢ as previously used; fᵢ replaces Yᵢ. For the semi-supervised variant of the method this algorithm was modified, to allow incorporation of available independent partial knowledge on the variability (see the section below entitled “Detailed exemplary description for determining the analysis”). After such a curve is found, each point xᵢᵢ, that represents sample i in S_{P}′, is projected onto fᵢ its closest point on the curve. The deregulation score D_{P}(i) of sample i is defined as the distance along the curve between fᵢ and a reference point r. If additional (supervised) ranking is provided, the reference point r is chosen to be the projection of the sample with the lowest rank. If no guiding ranking is provided, the reference point r is defined as the projection onto the curve of the centroid of some reference set of samples. In this case the reference set is used to define the curve's direction, by making sure the point representing the median coordinates of the reference set is closer to the beginning of the curve (flip the curves direction otherwise). In this study, the reference set is comprised of the healthy samples from the same tissue (henceforth “normal samples”), which indeed tend to concentrate on one side of the curve, due to the high similarity among normal samples and the large difference from tumor samples. The distance D_{P}(i) provides a measure of the extent to which the expression levels of the genes associated with pathway P were perturbed in sample i by the disease.

In some cases the normal samples fall roughly in the middle of the curve. When this happens, the curve captures two different kinds of deregulation, with samples moving away from the normal samples along two distinct paths. In principle one can use other (than normal) samples as reference, though doing this makes sense only in cases when the inner variability of the new reference set is considerably smaller than the overall variability.

Finding a Stable Gene Set

Often some of the genes in the gene set are noisy (in the sense that their variation does not reflect information relevant to the biology to be analyzed, see Discussion), and they are preferably omitted. Since the analysis is performed in S_{P}′ and not in S_{P}, metagenes (linear combinations of genes) are optionally and preferably omitted, but similar considerations imply that some of the metagenes might be noisy and should be omitted. This is partly taken care of by omitting genes and metagenes that don't vary much, but some of the noise might be due to highly varying metagenes, where most of the variation is unrelated to the biological information captured by the gene set.

To find out which metagenes should be omitted, one at a time, those metagenes were selected along which the samples were farthest from the curve, as expected for noisy metagenes, and found after each omission the new corresponding principal curve. To assess which curve is the best, the sensitivity of the gene set's scores was compared to sampling noise (the variance over 100 repeats of 80% of the samples selected randomly each time). If there is a significant improvement in the stability, the metagene was omitted whose omission yielded the most stable curve, and continue in a greedy fashion. If the improvement is not significant (or stability actually becomes worse), the process stops.

Principal Curves

The concept of principal curve was first proposed by Hastie and Stuetzle²⁰ as a non-parametric nonlinear extension of the linear Principal Component Analysis. By f(λ) a curve in p-dimensional space is denoted, where λ is a single parameter whose variation traces all the points along the curve. A curve f is defined to be a principal curve associated with a distribution P(x) defined over some space, if and only if it is a smooth, one dimensional non intersecting curve that is self-consistent, i.e. each point y on the curve is the expected value of all the points x whose projection onto the curve is y. Let the projection index λ_{f} (x) be the value of λ for which the projection of x on the curve is f(λ), i.e.:

$${λ}_{f} ( x ) = {sup}_{λ} \{ λ \text{:} ‖ x - f ( λ ) ‖ = {inf}_{μ} ‖ x - f ( μ ) ‖ \}$$

The condition for self-consistency is simply

f(λ)=E(X|λ_{f}(X)=λ)

Since in practice one is given a finite data set X, of n points in d_{P} dimensional space XεM_{n×d}_{_{P}}(R), while the distribution it is sampled from is not known, scatterplot smoothing is used. Hastie and Stuetzle also offer a two-steps iterative algorithm for finding such a principal curve:

1. Conditional-Expectation step: Fix λ={λᵢ}ᵢ₌₁ⁿ and minimize E∥X−f(λ)∥ by setting f(λᵢ) to be the local average (of the points projected onto a neighborhood of f(λᵢ), e.g. the points xⱼ for which λⱼ≃λᵢ).

2. Projection step: Given f={f(λᵢ)}ᵢ₌₁ⁿ find for each xᵢ the corresponding value of λᵢ=λ_{f}(xᵢ) assuming f is piecewise linear.

The line along the first linear principal component is used as a starting curve, and the algorithm is iterated until convergence.

Since Hastie and Stuetzle's seminal publication, many alternatives and generalizations were offered⁵⁶⁻⁶¹, but they all focused on unsupervised learning, not allowing the incorporation of additional information. In particular, another non-linear trajectory, defined in the full expression space, was used to capture tumor progression⁶². This Example comprises a modification to Hastie and Stuetzle's algorithm that allows introduction of prior belief on the order of the curve parameter {λᵢ}ᵢ₌₁ⁿ. This prior affects the estimation of the distribution from which X is sampled, and therefore generates a modified principal curve.

Detailed Exemplary Description for Determining the Analysis:

### Principal Curves

The concept of principal curve was first proposed by Hastie and Stuetzle (1) as a non-parametric nonlinear extension of the linear Principal Component Analysis. In this Example, one denotes by f(λ) a curve in p-dimensional space, where λ is a single parameter whose variation traces all the points along the curve. A curve f is defined to be a principal curve associated with a distribution P(x) defined over some space, if and only if it is a smooth, one dimensional non intersecting curve that is self-consistent, i.e. each point y on the curve is the expected value of all the points x whose projection onto the curve is y. Let the projection index λ_{f} (x) be the value λ of for which the projection of x on the curve is f(λ), i.e.:

$${λ}_{f} ( x ) = {sup}_{λ} \{ λ \text{:} ‖ x - f ( λ ) ‖ = {inf}_{μ} ‖ x - f ( μ ) ‖ \}$$

The condition for self-consistency is simply

f(λ)=E(X|λ_{f}(X)=λ)

Since in practice one is given a finite data set X, of n points in d_{P} dimensional space XεM_{n×d}_{ₚ}(R), while the distribution it is sampled from is not known, scatterplot smoothing is used. Hastie and Stuetzle also offer a two-steps iterative algorithm for finding such a principal curve:
1. Conditional-Expectation step: Fix λ={λᵢ}ᵢ₌₁ⁿ and minimize E∥X−f(λ)∥ by setting f(λᵢ) to be the local average (of the points projected onto a neighborhood of f(λᵢ), e.g. the points xⱼ for which λⱼ≃λᵢ).
2. Projection step: Given f={f(λᵢ)}ᵢ₌₁ⁿ find for each xᵢ the corresponding value of λᵢ=λ_{f}(xᵢ) assuming f is piecewise linear.

The line along the first linear principal component is used as a starting curve, and the algorithm is iterated until convergence.

Since Hastie and Stuetzle's seminal publication, many alternatives and generalizations were offered (2-7), but they all focused on unsupervised learning, not allowing the incorporation of additional information. In particular, another non-linear trajectory, defined in the full expression space, was used to capture tumor progression(8).

Integration of External Information: Semi Supervised Principal Curve

Here a modification to Hastie and Stuetzle's algorithm is described that allows introduction of prior belief on the order of the curve parameter {λᵢ}ᵢ₌₁ⁿ. This prior affects the estimation of the distribution from which X is sampled, and therefore generates a modified principal curve. Finding a principal curve is closely related to finding the “correct” order to go through the data points. A curve explicitly defines that order (the ranking of {λᵢ}ᵢ₌₁ⁿ), and given an order, a curve could be deduced, e.g. by Hastie and Stuetzle's(1) Conditional-Expectation step (or any other data fitting approach). Therefore, if one has detailed information on the order, finding the curve is very simple. However, if one has only vague or imprecise information, one is facing the full problem of finding a principal curve, but the information still might help us to improve identification of the desired curve. This knowledge is captured by assuming that the Spearman correlation of λ={λᵢ}ᵢ₌₁ⁿ and a vector of some (approximately known) ranking is high. Spearman correlation was selected as a non-limiting exemplary correlation since (a) it requires only the knowledge of ranks (allowing ties to represent uncertainties), and not the explicit values of some variable, and (b) it does not depend on the specific details of the curve parameterization.

Notice that in Hastie and Stuetzle's algorithm, the conditional-expectation step is not affected by ranking prior, as the {λᵢ}ᵢ₌₁ⁿ are given and fixed. Therefore only the projection step is adapted, in a way that incorporates the above described prior. The projection step is equivalent to minimizing ∥xᵢ−f(λᵢ)∥ for every 1≦i≦n. It is desirable to simultaneously maximize the Spearman correlation

$$ρ = 1 - \frac{6 \sum {{d}_{i} ( {λ}_{i} )}^{2}}{n ( {n}^{2} - 1 )} ,$$

where dᵢ (λᵢ) is the difference between the rank of λᵢ and the rank of i in the given guiding ranks vector. Therefore, the minimized function can be written as

$$( 1 - α ) {\sum }_{i = 1}^{n} {‖ {x}_{i} - f ( {λ}_{i} ) ‖}^{2} + α \frac{6 \sum {{d}_{i} ( {λ}_{i} )}^{2}}{n ( {n}^{2} - 1 )} ,$$

where α reflects confidence in the ordering.

Thanks to the iterative framework, it is not necessary to find the global minimum in each step. Therefore, the method used a greedy approach to save computation. First one computes for every xᵢ the distance to each segment of the curve, and then one selects the νᵢ=λᵢ that minimize the distance. Given these {νᵢ}ᵢ₌₁ⁿ, the following is selected for every

$$1 \leq i \leq n$$

$${λ}_{i} = {argmin}_{μ} \{ ( 1 - α ) \frac{1}{{d}_{p}} {‖ {x}_{i} - f ( μ ) ‖}^{2} + α \frac{6}{( {n}^{2} - 1 )} ( {{d}_{i} ( μ )}^{2} - {{d}_{i} ( {v}_{i} )}^{2} ) \}$$

that is, the λᵢ that minimizes the weighted sum of the distance and the difference in contribution to the correlation term, given that all the other λ's remain the same. Notice that the first term was divided by d_{P} and the second multiplied by n, so that both terms will be independent of d_{P} and n, but this does not harm the optimization as it can be introduced back via α.

As noted in (2), Hastie and Stuetzle's algorithm can be analyzed from a probabilistic point of view. A principal curve with cubic spline smoothing is the solution for maximizing the likelihood that the curve generated the given data, assuming Gaussian noise and a prior on the smoothness of the curve. This modification, therefore, can be viewed as adding another prior, according to which the probability of a curve with {λᵢ}ᵢ₌₁ⁿ is

$$Pr ( λ ) = {e}^{- \frac{6 {d}_{p} α ( {{d}_{i} ( {λ}_{i} )}^{2} - {{d}_{i} ( {v}_{i} )}^{2} )}{( 1 - α ) ( {n}^{2} - 1 )}}$$

In addition, since some ranking is known, the initial guess is set to be piecewise linear, generated by first calculating the average of all the points with the same rank, and connecting the averages corresponding to consecutive ranks. If the rank of most points is unknown, this might be a poor guess and one therefore starts with the first principal component, making sure that its direction does not impose a reverse order to that of the ranking.

Setting the Weight α

In order to automatically learn a suitable value of a, the following heuristic may optionally be employed. Find the best curve for a set of values of αε[0,1) (say, in steps of 0.05) and record for each one the sum of squared distances of the data points to the curve, D(α), as well as the Spearman correlation ρ(a) between {λᵢ}ᵢ₌₁ⁿ and the labels. Ideally, one would like to minimize the distance and maximize the correlation. However, as that is unlikely to occur simultaneously, one needs to assign these two demands some weights.

One can therefore weigh the minimization goal g(α,R)=D(α)−Rρ(α), so that the right choice of R will allow us to select the best a. One possibility is to set

$$R = \frac{α}{1 - α} ,$$

or any other similar function of a, but this might lead to over or under-estimation of α—for example, if the maximal correlation is low, one would choose R=0, so that the correlation will not affect the target function, but this will force us to select α=0, even though a higher value may be more appropriate, as it will improve the correlation with almost no effect on the distance. Therefore, one needs to weigh the two terms in a way that is independent of a, yet flexible enough to handle those cases when both terms can be minimized considerably, as well as cases when one cannot find a low enough minimum for one of the terms. To achieve this, one can minimize the difference between the standardized terms, that is:

$$α = {argmin}_{0 \leq α < 1} \{ \frac{D ( α ) - \overline{D}}{\sqrt{Var ( D )}} - \frac{ρ ( α ) - \overline{ρ}}{\sqrt{Var ( ρ )}} \}$$

The mean and the variance are taken over the different values achieved for the different α's.

In many cases one may use the ranking information only to guide the curve learning process, and not to set the actual final projection. To achieve that one performs an additional iteration with no ranking information (α=0). One reason one would want to do this is that often the ranking information cannot be trusted, or one is not confident of its relevance to the gene set in question. Another related reason is that since one already knows the guiding ranking, new information that can be obtained from the gene set is more interesting, even at the cost of losing consistency with the guiding ranking. Furthermore, the curve can be used to score new samples, for which no ranking information is available (for example using patient survival as the guiding ranking, and then predicting survival for a new patient on the basis of its projection onto the curve). In this the case the curve's performance should be assessed in the same framework in which it is meant to be applied; that is, with no available ranking information.

A Simulated Example for Semi-Supervised Principal Curves

Suppose one measures the location of a particle over time. The location measurements are a little noisy, and the time measurements are very noisy, to the extent that it is only possible to determine whether the measurement was done at time t=0 or t=1 (e.g. the particle moves very fast). One would like to deduce the trajectory from the data. Approximately linear trajectories are easy to deduce, but complex ones require using principal curves or similar methods. In this simple example the trajectory (r sin θ, r cos θ) was selected with Gaussian noise with standard deviation 0.3, where rε[1, 3] and θε[0, 2π].

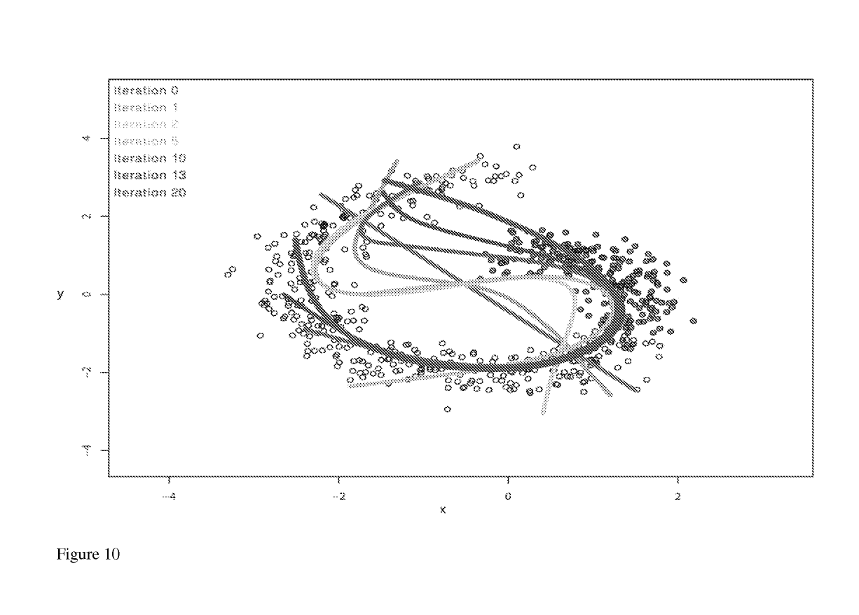

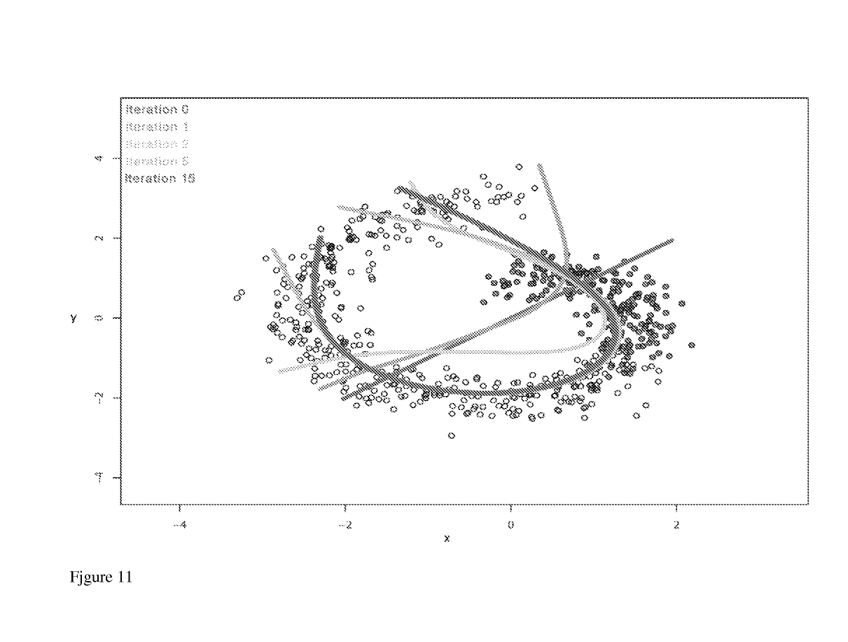

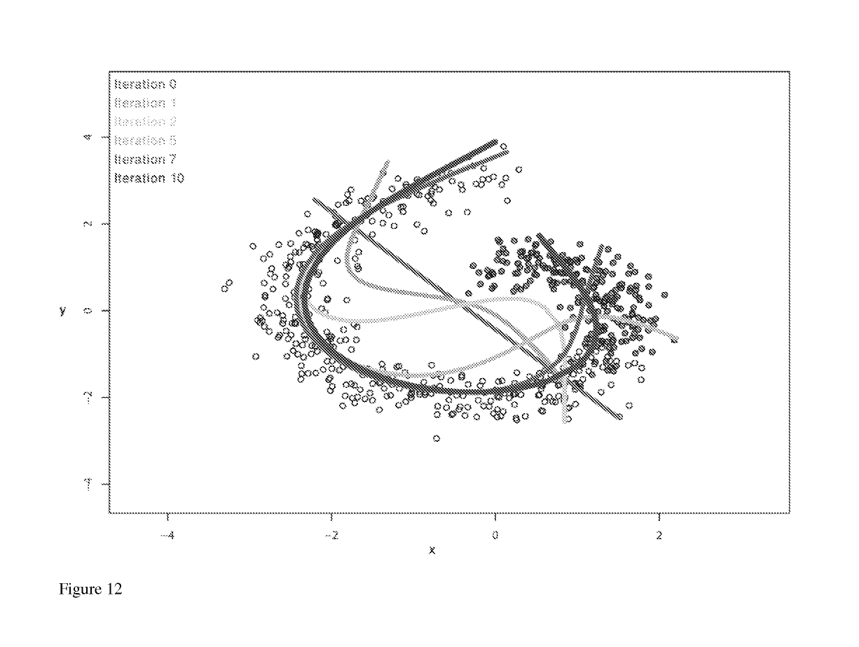

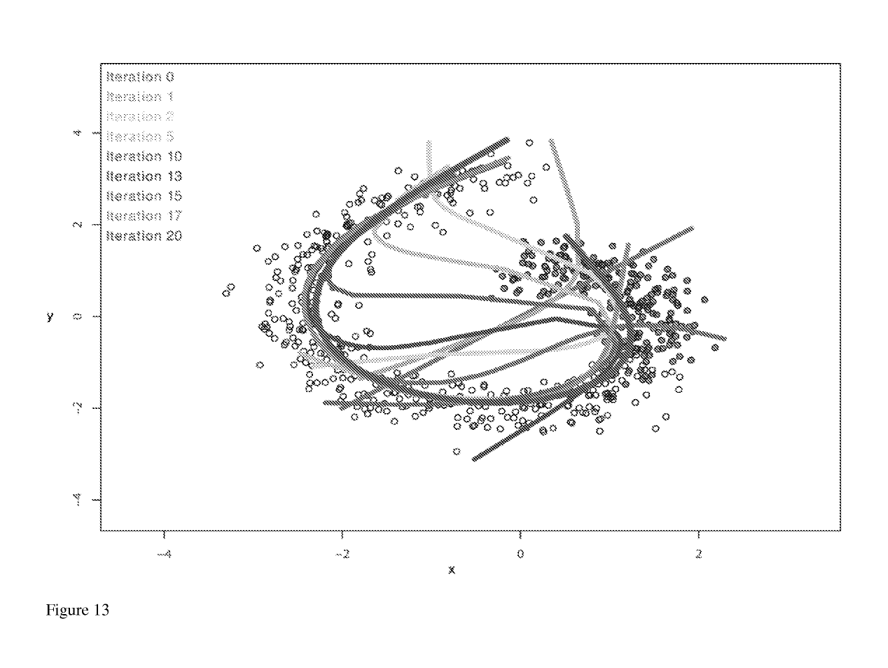

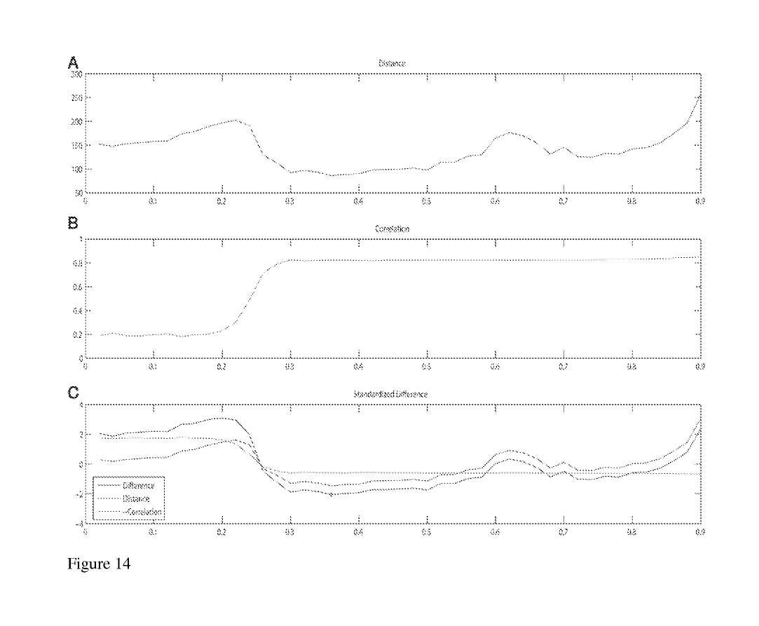

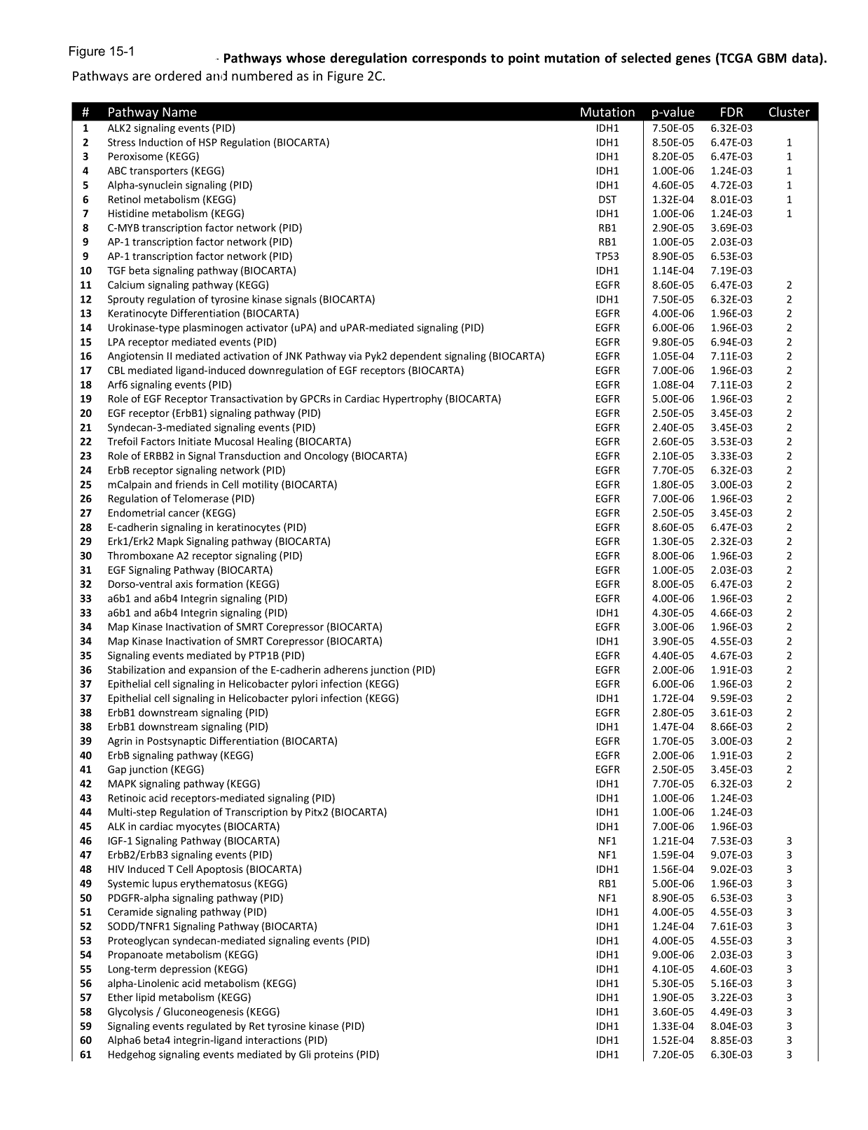

As expected, an unsupervised principal curve fails to capture the correct trajectory (see FIG. 10). A possible way to introduce the knowledge of time could be in the initial guess. Accurate enough time measurements indeed allow the principal curve to get stuck in the correct local minimum. However in this case where time measurement is vague, this trick does not work—stating from the line connecting the center of the t=0 points and the t=1 points doesn't help (see FIG. 11). The modified algorithm handles this well, whether starting from the first principal component or not (FIGS. 12 and 13). FIG. 14 shows how α=0.36 was selected, using the automatic standardized difference approach.

Data and Preprocessing

GBM mRNA expression data was downloaded from TCGA data portal on April 2011 (9). To reduce batch effects of arrays and protocols, only data from Agilent G4502A arrays measured at the UNC medical school were used, yielding 455 samples, 10 of which were from normal tissue. Additionally, 228 glioblastoma samples and 28 normal brain samples were obtained from REMBRANDT (10). Subtypes classification was taken from Veerhak et al. (11) Classification of the REMBRANDT data and additional TCGA samples was done using the same genes. Colorectal mRNA data was taken from Sheffer et al. (12) which contains 313 samples including normal tissue (52 samples), polyps (49), primary tumors (182) and metastases from the liver (21) and lung (9); Sveen et al. (13) containing 13 normals and 76 primary tumors of stages 2,3 (one tumor sample was removed); and Kogo et al. (14) containing 9 normal and 132 primary tumors of all stages.

For TCGA data level 3 already processed data was used and for Kogo data the downloaded processed data was used. For all the rest, data was summarized with PLIER and normalized with cyclic LOWESS (15). To eliminate noisy genes only the 5000 most varying genes for each cancer type (sum of variation on all 2 or 3 datasets) were selected for further analysis.

Assembly of Pathway Associated Gene Sets

Gene sets were imported from three pathway databases, KEGG (16, 17), BioCarta (18) (both downloaded from MSigDB (19)) and the NCI-Nature curated Pathway Interaction Database (20). Identity of genes in gene sets was decided according to their official gene symbols. Gene sets with less than 3 genes varying in the data were omitted, leaving 173 KEGG pathways, 188 BioCarta pathways and 197 NCI-Nature PID pathways.

Chromosomal Instability Index

Chromosomal instability index (CIN) was deduced from gene expression, following reference (12). For a given tumor sample, each chromosomal arm was scored as follows. For every gene i calculate fcᵢ the fold change versus the median expression of the gene in the normal samples. The median fold change of the chromosomal arm a is defined as

$${fc}_{a} = {median}_{i ∈ a} {fc}_{i} .$$

The total chromosomal instability index is the sum (over all arms) of the squared median fold changes

$$CIN = {\sum }_{a} {fc}_{a}^{2} .$$

Spearman correlation between the CIN index and the deregulation score of every pathway was calculated across each colorectal dataset. The list of pathways passing 5% FDR for every dataset was recorded. The Fisher exact test was applied to evaluate the significance of the similarity between every pair of pathway lists.

Pathway Deregulation Scores that are Correlated with Necrosis Levels of Glioblastoma

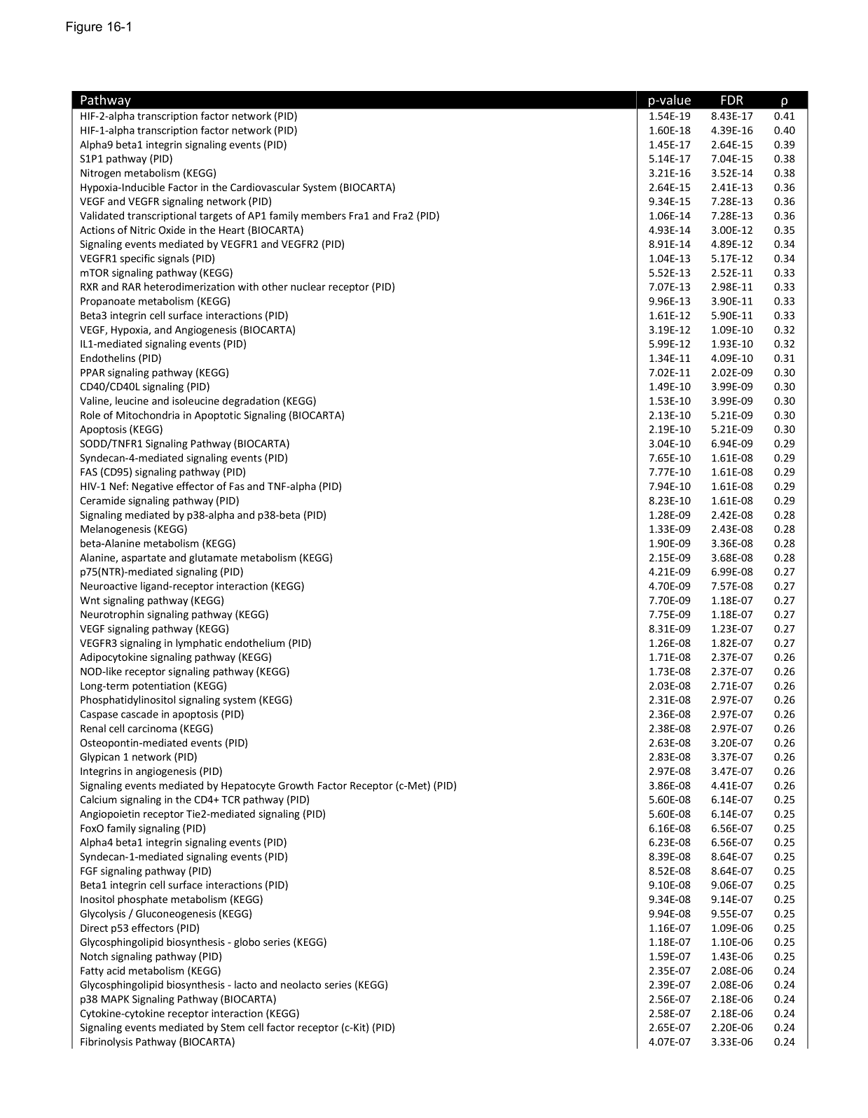

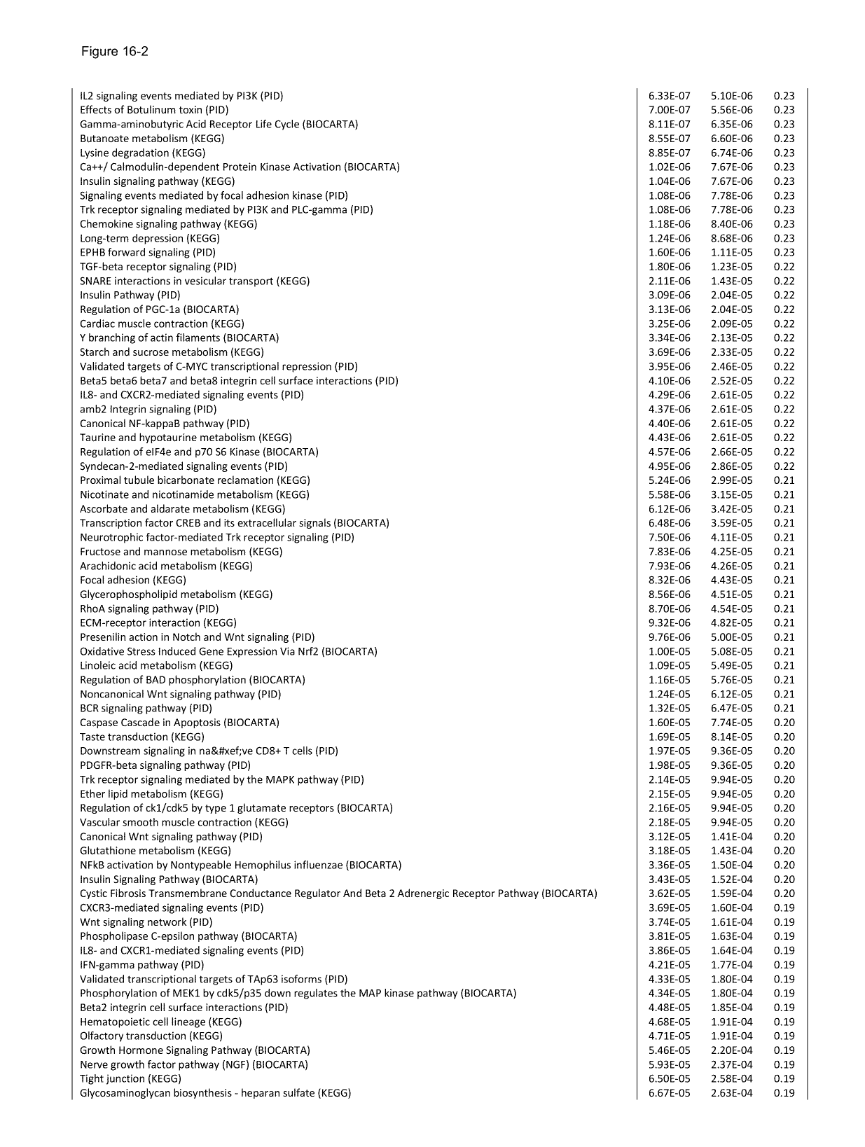

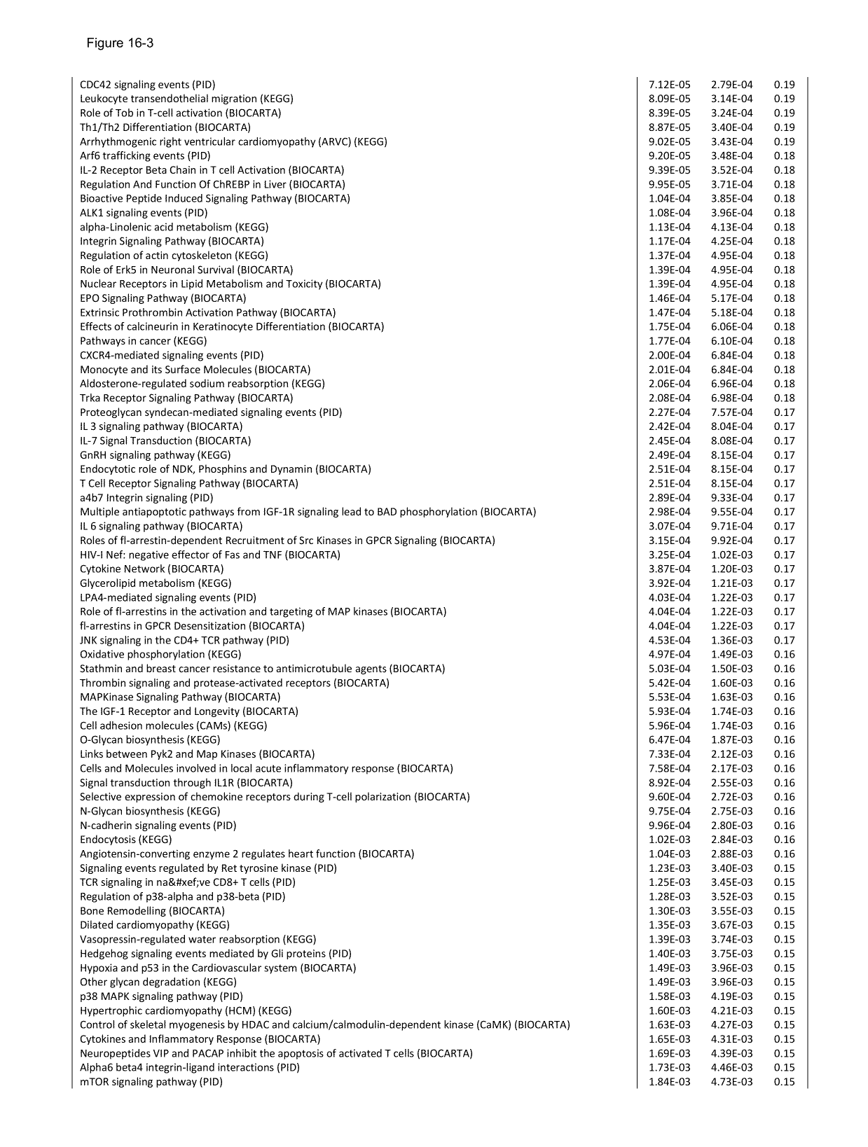

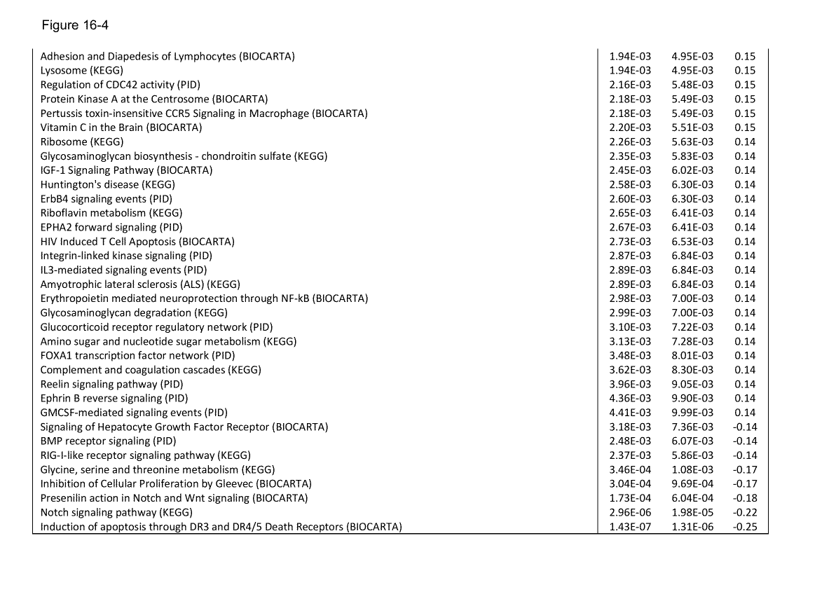

The PDS of 242 pathways significantly correlate with the necrosis levels of the samples, as quantified by TCGA (FDR<1%), see FIG. 16. Some of these pathways are indeed expected to cause cell death, such as: SODD signaling, FAS pathway, NEF pathway, BAD phosphorylation pathway, apoptosis, caspase pathway, Notch signaling, Induction of apoptosis through DR3 and DR4/5 Death Receptors, p75(NTR)-mediated signaling, oxidative stress induced gene expression via NRF2 and ERK5 in neuronal survival. Many of the other pathways are growth factor pathways, such as: NGF, ERBBs, PDGFRB, IGF, and Trk receptor pathways. A few hypoxia and angiogenesis related pathways are also correlated with necrosis (VEGF pathways, HIF pathways, angiopoietin receptor pathway, lymphangiogenesis pathway, Hypoxia and p53 in the Cardiovascular system).

Pathway Clusters in the TCGA GBM Dataset

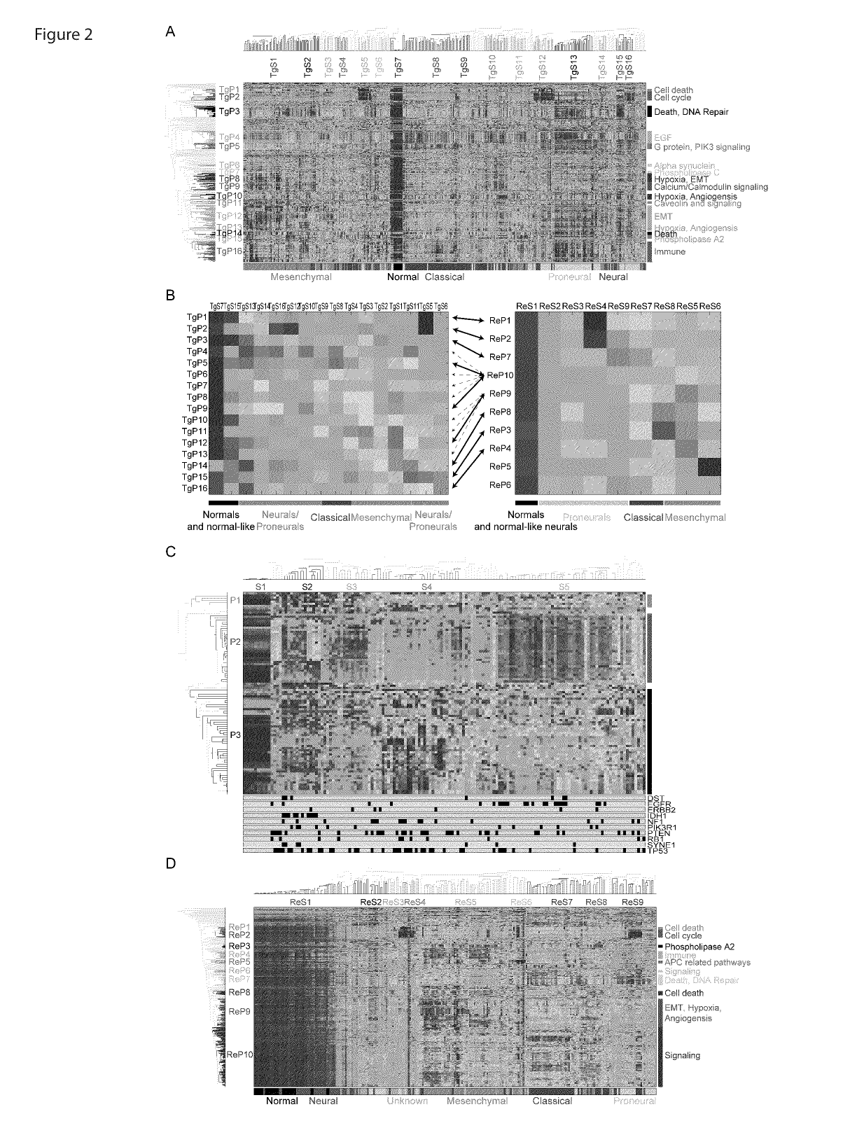

Pathway cluster TgP1 consists of cell cycle arrest and cell death pathways; TgP2 contains cell cycle pathways and many of KEGG's “cancer” pathways (including glioma) which capture cancer progression and signaling; TgP3 contains mainly cell death and DNA repair pathways and is deregulated mostly on the Neural and Proneural samples; The pathways of cluster TgP4 correspond to the EGF activated pathways mentioned above; Cluster TgP5 contains pathways that are deregulated mostly on the Classical samples. Some of them are indeed suspected to be specific to this subtype, such as hedgehog-GLI signaling(11) and GPCR/CXCR4 signaling(21) while the deregulation of some others in this subtype is a new prediction: such as PAR1(F2R)-mediated thrombin signaling, axon guidance, etc.; Half of the TgP6 pathways involve alpha synuclein amyloids; All TgP7 pathways involve phospholipase C; the pathways that comprise clusters TgP8-TgP10, TgP12-TgP15 belong to the 242 pathways that were correlated with necrosis that were mentioned above, and are also highly expressed on many Mesenchymal samples. As mentioned, many of these pathways (and specifically the pathways of TgP8-TgP10, TgP13 and TgP15) are related to hypoxia and angiogenesis, and it was found, in agreement with previous knowledge, that they score higher in Mesenchymal glioblastoma(22). Clusters TgP8 and TgP12 contain several Epithelial-Mesenchymal Transition (EMT) related pathways (such as N-cadherin signaling, epithelial tight junctions, Rho/Rac/CDC42 signaling, regulation of actin cytoskeleton, ECM-receptor, Focal adhesion) obviously related to Mesenchymal tumors; 7 of the 8 pathways of TgP11 are key signaling pathways involving caveolin; TgP12 contains many of the pathways correlated with NF1 mutation (P3 in FIG. 2C); TgP14 contains mostly cell death pathways; TgP15 pathways all involve phospholipase A2; TgP16 contains many immune pathways.

Matching Between Rembrandt and TCGA GBM Pathway Clusters

Cluster ReP1 matches TgP1, ReP2 matches TgP2, ReP3 matches TgP15, ReP4 matches TgP16, ReP7 matches TgP3, ReP8 matches TgP14, ReP9 includes parts of TgP10-TgP13 (most strongly related to TgP12), and ReP10 includes parts of TgP4-TgP9 (most strongly related to TgP5 and TgP9). Under this mapping, similar characteristics of the deregulation profiles of sample types emerge (FIG. 2B). Some of the Neurals/Proneurals are mostly not deregulated (ReS1/ReS2 vs. TgS7/TgS15/TgS13) and some are deregulated on TgP1/TgP2/TgP3 or the matching ReP1/ReP2/ReP7. Classical tumors are deregulated on TgP4/TgP5 and possibly TgP6/TgP7 as well as on the matching ReP10 (and unmatched ReP6/ReP7). Pathways of clusters TgP8-TgP16 as well as the matching ReP10/ReP9/ReP8/ReP3/ReP4 (and unmatchable ReP5) are highly deregulated in the Mesenchymal samples. The Classical-Mesenchymal cluster TgS4 matches ReS8, and indeed the corresponding samples are deregulated on TgP4-TgP5/TgP10-TgP12/TgP14-TgP15 and, respectively, on the matching ReP10/ReP9/ReP8/ReP3 (as well as on the unmatchable ReP5).

Deregulation Scores of Many Pathways are Correlated with Survival of GBM Patients

35 pathways were found to be related to survival in both GBM datasets (see Table 1), many of them make biological sense: Agrin deregulation may temper the blood-brain barrier in glioblastoma(23); Growth hormone (GH) plays a crucial role in stimulating and controlling the growth, metabolism and differentiation of many mammalian cells, and hence clearly relevant for cancer aggressiveness(24); The hematopoiesis pathway contains cytokines and it is suspected to be related to cancer progression and drug resistance by interactions with the immune system(25-27); Linolenic acids and their products were suggested to prolong cancer patient survival(28); FcεRI may protect against cancer by IgE antitumor immunity(29); Cell-matrix adhesions are clearly related to invasion and metastasis(30); GnRH is a neurohormone that may drive proliferation in glioblastoma and other cancers, and therefore is also a suggested drug target(31-36); Phosphatidyl-inositol 3- and 4-kinases, key ingredients of the inositol phosphate pathway, are known to have important roles in glioblastoma and cancer in general, and hence are possible drug targets(37-39); Surprisingly, cholera toxin was also found related to glioblastoma; WNT signaling has a key role in brain and other cancers, and is related to cancer stem-like cells and poor prognosis(40-42); Alterations in E-cadherin mediated cell-cell adhesion are associated with an increase in carcinoma cell motility, invasiveness and metastasis(43); Glypican-1 is crucial for efficient growth, metastasis, and angiogenesis of cancer, and lack of it slows down pancreatic tumor progression(44); Fas and TNF-alpha are key players in apoptosis whose deregulation is a clear hallmark of cancer(45, 46); α4β1 integrin is related to angiogenesis(47), and is involved the survival and chemoresistance of several types of cancer(48); P2 integrins are known to predict poor survival in blood cancers(49, 50), and may cause fibrinolysis via uPA/uPAR; α6 integrin regulated stemness and invasiveness in glioblastoma(51, 52), and has a prognostic value in breast cancer(53); P53 is a key player in glioblastoma and cancer in general; PTPN1 (aka PTP1B) may promote apoptosis in cancer and is a possible drug target for gliomas(54); Reelin is a secreted glycoprotein guiding migratory neurons, it is downregulated in neuroblastoma, which may contribute to metastasis(55, 56); Syndecans induce proliferation and invasion(57-59), and may serve as a prognostic predictor(60, 61).

Deregulation Scores of Many Pathways are Correlated with CIN in Colorectal Tumors

84 pathways were found to have significant positive correlation with the estimated CIN level in the tumors. To check that this correlation does not reflect only the differences between the MSI-high (most with low CIN) and MSS (most with high CIN) subtypes, the correlations for the subset of MSS and MSI-low tumors of the Sheffer and Sveen datasets were recalculated. 71 pathways were significant (p<0.046, Fisher exact test), with an overlap of 55 with the previously found 84 pathways, suggesting that the correlations between CIN and deregulation of tumorigenic pathways is not only due to the differences between MSS and MSI-high tumors.

Deregulation Scores in MSS Colorectal Tumors Compared with MSI-High

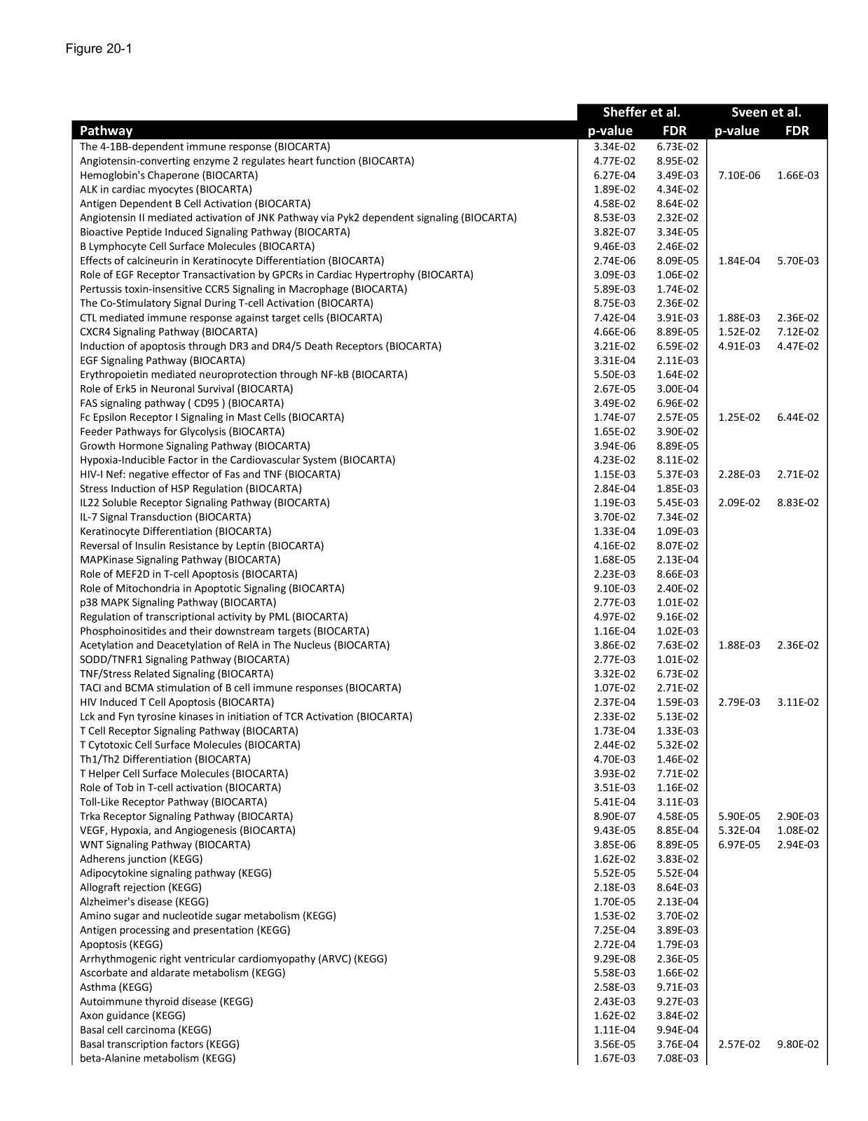

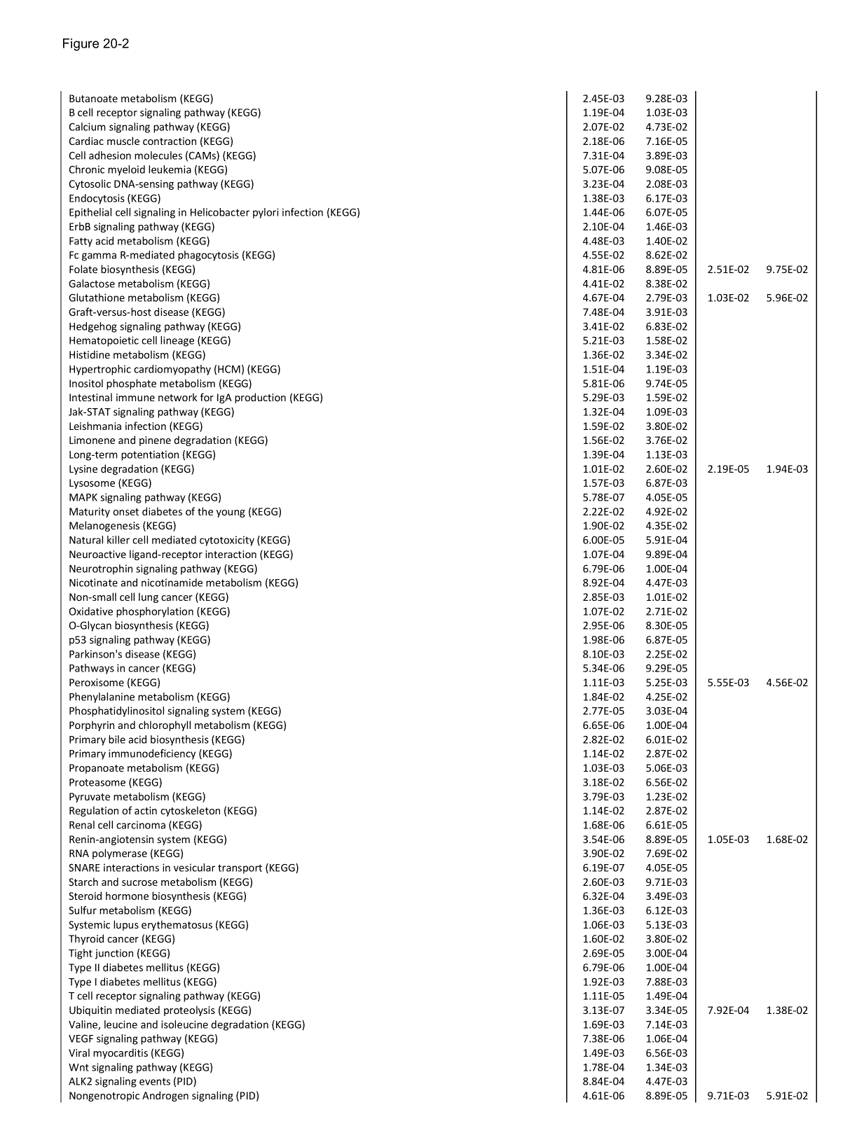

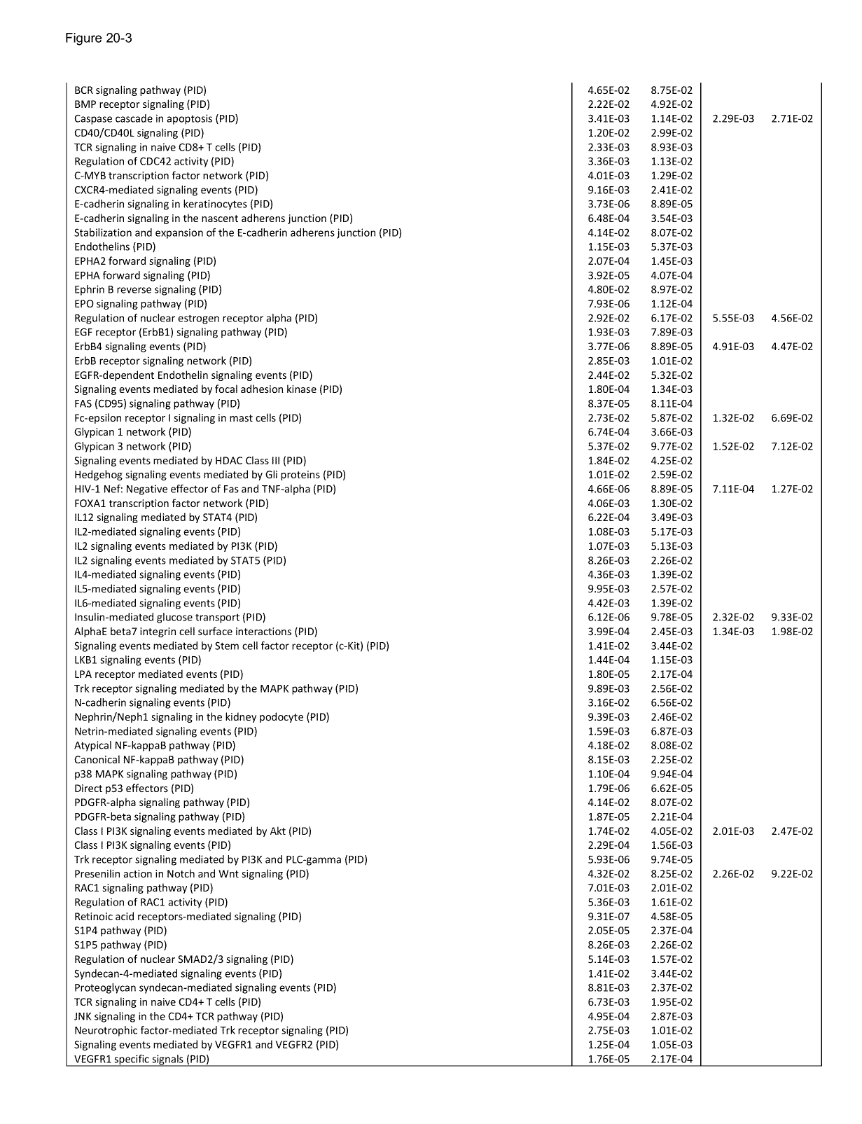

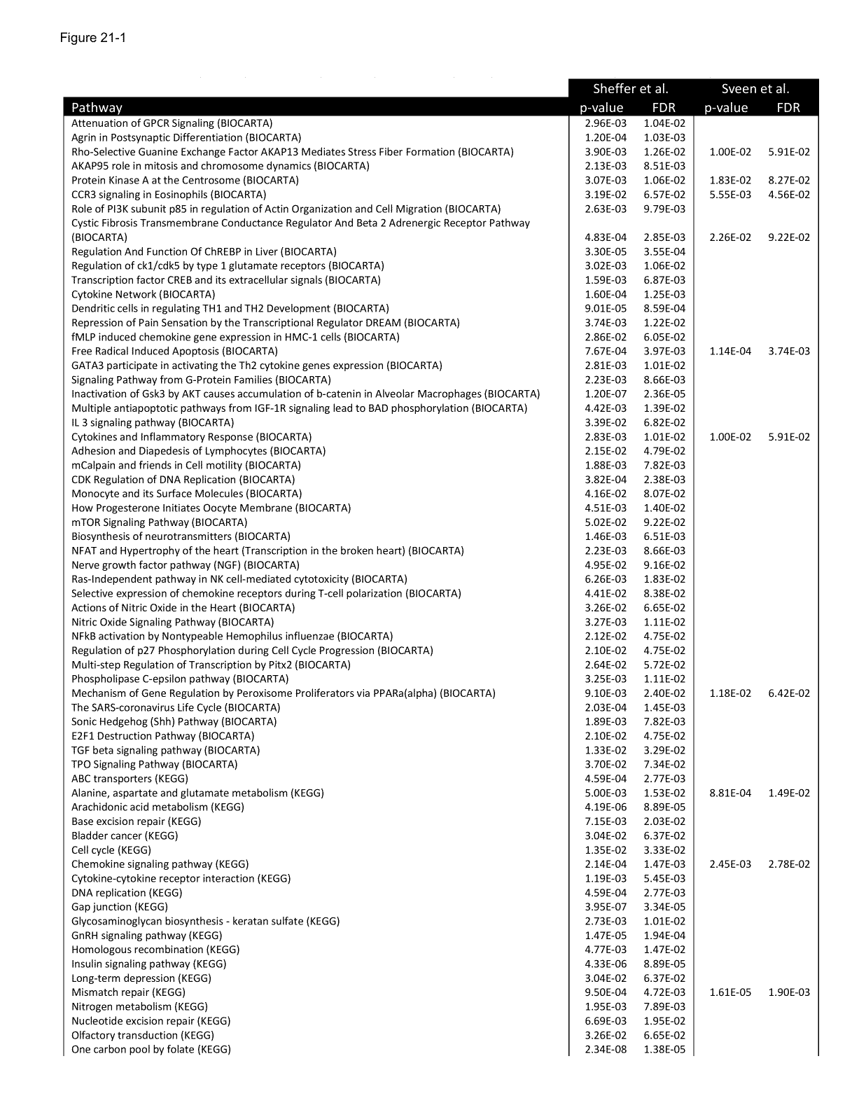

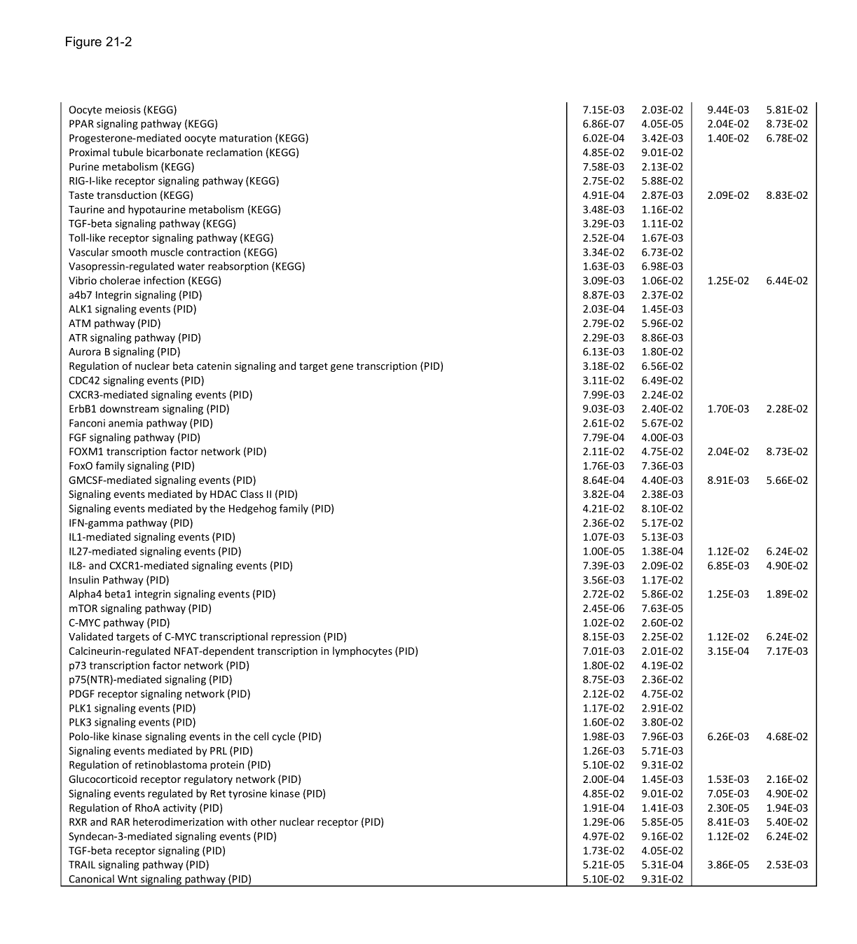

In the Sheffer dataset, 325 pathways are differentially deregulated between MSS and MSI-high tumors (Mann-Whitney, 10% FDR, FIG. 20). 120 pathways are more deregulated on MSI-high tumors: They include Mismatch repair, nucleotide excision repair, ATM pathway, ATR pathway, cell cycle, MCM, DNA replication, RB1 pathway, oxidative stress, chemokines and cytokines signaling, and different interleukin pathways. This differential deregulation is in agreement with the fact that DNA mismatch repair is deregulated in MSI tumors(62), which are usually characterized by higher levels of inflammation and tumor infiltrating lymphocytes(63). A significant part of these pathways was also deregulated in the MSI-high tumors in the Sveen dataset (p=1.92×10⁻⁵ for MSS deregulated pathways, p=0.022 for MSI-high, Fisher exact test, FIG. 20). It is reassuring that the mismatch repair pathway is deregulated in MSI-high tumors, in both datasets. Almost all pathways that are deregulated in MSS in the Sheffer dataset (200/205, 98%) also show significant positive correlation with the CIN index. Interestingly, in the MSS tumors, where p53 mutation is frequent, pathways downstream of p53 are highly deregulated (KEGG's p53 signaling pathway and PID's direct p53 effectors, which focus of the downstream effects of p53, as well as many death pathways), while in the MSI tumors, where p53 is often functional, many pathways upstream of p53 are deregulated (i.e. DNA damage and cell cycle). Indeed, it was found that 123 out of 140 pathways that are differentially deregulated between wild type and mutant p53 (Mann-Whitney, 5% FDR) were shared with the group of 325 pathways deregulated in either MSI-high or MSS.

Pathway Clusters in the Sheffer Colorectal Dataset

ShP1 includes B-cell receptor and T-cell receptor pathways, and ShP2 includes antigen processing and presentation, T-cell differentiation, T helper cell surface molecules, T cytotoxic cell surface molecules, Graft-versus-host disease, Autoimmune thyroid disease etc. Clusters ShP4 and ShP5 include ECM pathways, focal adhesion, syndecan pathways, integrin pathways such as α9/β1 that induce adhesion and migration of endothelial and cancer cells(64); interleukines that mediate inflammation and angiogenesis(65); toll like receptors, that are involved in innate immune response and HIF2, a transcription factor that induces the hypoxia response. Other pathways are related to metabolism, such as glycolysis and drug metabolism. Cluster ShP7 includes regulation of actin cytoskeleton, cell adhesion, JAK/STAT signaling, MAPK signaling and complement and coagulation cascades pathway. Interestingly, this cluster is also deregulated in the polyps (cluster ShS2), although polyps show low level of CIN. Cluster ShP8 includes various cAMP-dependent signaling pathways, triggered by receptor binding to GPCRs involving the G-Protein such as insulin and BAD phosphrylation. Other pathways include metabolism of different amino acids and TGF-beta signaling. Cluster ShP9 includes a number of death associated pathways such as apoptosis, T-cell apoptosis, p53 downstream signaling, lysosome and FAS signaling. In addition, it includes also fatty acid metabolism, VEGF, mTOR, and notch signaling. Cluster ShP10 includes mitochondrial metabolic pathways such as pyruvate metabolism, TCA cycle, metabolism of sugars and oxidative phosphorylation. Cluster ShP11 includes cell cycle related pathways such as G1/S check point, aurora pathway, p53 upstream regulation, E2F, RB1, MCM, DNA replication, mismatch repair, purine metabolism, and more.

72 pathways out of the 106 that exhibited increase of PDS with progression of the disease (see above) belong to clusters ShP8, ShP9 and ShP10 (p<10⁻³ for all three clusters, Fisher exact test). This group of pathways consist of cell death, cAMP-dependent signaling and mitochondrial metabolism pathways, along with p53 pathways.

### REFERENCES

1. Hastie T & Stuetzle W (1989) Principal Curves. J Am Stat Assoc 84(406):502-516.
2. Tibshirani R (1992) Principal curves revisited. Stat Comput 2(4):183-190.
3. Leblanc M & Tibshirani R (1994) Adaptive Principal Surfaces. J Am Stat Assoc 89(425):53-64.
4. Bishop C M, Svensen M, & Williams C K I (1998) GTM: The generative topographic mapping. Neural Comput 10(1):215-234.
5. Kegl B, Krzyzak A, Linder T, & Zeger K (2000) Learning and design of principal curves. Ieee T Pattern Anal 22(3):281-297.
6. Delicado P (2001) Another look at principal curves and surfaces. J Multivariate Anal 77(1):84-116.
7. Lawrence N (2005) Probabilistic non-linear principal component analysis with Gaussian process latent variable models. J Mach Learn Res 6:1783-1816.
8. Urbach S (2006) Modeling Cancer Progression Using Microarray Data. MSc (MSc Thesis, Weizmann Institute of Science, Rehovot).
9. TCGA (2008) Comprehensive genomic characterization defines human glioblastoma genes and core pathways. Nature 455(7216):1061-1068.
10. Madhavan 5, et al. (2009) Rembrandt: helping personalized medicine become a reality through integrative translational research. Mol Cancer Res 7(2):157-167.
11. Verhaak R G, et al. (2010) Integrated genomic analysis identifies clinically relevant subtypes of glioblastoma characterized by abnormalities in PDGFRA, IDH1, EGFR, and NF1. Cancer Cell 17(1):98-110.
12. Sheffer M, et al. (2009) Association of survival and disease progression with chromosomal instability: A genomic exploration of colorectal cancer. Proceedings of the National Academy of Sciences 106(17):7131-7136.
13. Sveen A, et al. (Transcriptome instability in colorectal cancer identified by exon microarray analyses: Associations with splicing factor expression levels and patient survival. Genome Med 3(5):32.
14. Kogo R, et al. (Long noncoding RNA HOTAIR regulates polycomb-dependent chromatin modification and is associated with poor prognosis in colorectal cancers. Cancer Res 71(20):6320-6326.
15. Ballman K V, Grill D E, Oberg A L, & Therneau T M (2004) Faster cyclic loess: normalizing RNA arrays via linear models. Bioinformatics 20(16):2778-2786.
16. Kanehisa M & Goto S (2000) KEGG: kyoto encyclopedia of genes and genomes. Nucleic Acids Res 28(1):27-30.
17. Kanehisa M, Goto S, Sato Y, Furumichi M, & Tanabe M (2012) KEGG for integration and interpretation of large-scale molecular data sets. Nucleic Acids Res 40(Database issue):D109-114.
18. Nishimura D (2001) BioCarta. Biotech Software Internet Report 2(3):117-120.
19. Subramanian A, et al. (2005) Gene set enrichment analysis: a knowledge-based approach for interpreting genome-wide expression profiles. Proc Natl Acad Sci USA 102(43):15545-15550.
20. Schaefer C F, et al. (2009) PID: the Pathway Interaction Database. Nucleic Acids Res 37(Database issue):D674-679.
21. Woerner B M, et al. (2012) Suppression of G-protein-coupled receptor kinase 3 expression is a feature of classical GBM that is required for maximal growth. Mol Cancer Res 10(1):156-166.
22. Phillips H S, et al. (2006) Molecular subclasses of high-grade glioma predict prognosis, delineate a pattern of disease progression, and resemble stages in neurogenesis. Cancer Cell 9(3):157-173.
23. Rascher G, et al. (2002) Extracellular matrix and the blood-brain barrier in glioblastoma multiforme: spatial segregation of tenascin and agrin. Acta Neuropathol 104(1):85-91.
24. Thapar K, et al. (1997) Overexpression of the growth-hormone-releasing hormone gene in acromegaly-associated pituitary tumors. An event associated with neoplastic progression and aggressive behavior. Am J Pathol 151(3):769-784.
25. Ara T & DeClerck Y A (2006) Mechanisms of invasion and metastasis in human neuroblastoma. Cancer Metastasis Rev 25(4):645-657.
26. Penson R T, et al. (2000) Cytokines IL-1beta, IL-2, IL-6, IL-8, MCP-1, G M-CSF and TNFalpha in patients with epithelial ovarian cancer and their relationship to treatment with paclitaxel. Intl Gynecol Cancer 10(1):33-41.
27. van Rossum A P, et al. (2009) Granulocytosis and thrombocytosis in renal cell carcinoma: a pro-inflammatory cytokine response originating in the tumour. Neth J Med 67(5):191-194.
28. Eynard A R (2003) Potential of essential fatty acids as natural therapeutic products for human tumors. Nutrition 19(4):386-388.
29. Nigro E A, et al. (2009) Antitumor IgE adjuvanticity: key role of Fc epsilon RI. J Immunol 183(7):4530-4536.
30. Hauck C R, Hsia D A, & Schlaepfer D D (2002) The focal adhesion kinase—a regulator of cell migration and invasion. IUBMB Life 53(2):115-119.
31. van Groeninghen J C, Kiesel L, Winkler D, & Zwirner M (1998) Effects of luteinising-hormone-releasing hormone on nervous-system tumours. Lancet 352(9125):372-373.
32. Cook T & Sheridan W P (2000) Development of GnRH antagonists for prostate cancer: new approaches to treatment. Oncologist 5(2):162-168.
33. Marelli M M, et al. (2009) Novel insights into GnRH receptor activity: role in the control of human glioblastoma cell proliferation. Oncol Rep 21(5):1277-1282.
34. Park D W, Choi K C, MacCalman C D, & Leung P C (2009) Gonadotropin-releasing hormone (GnRH)-I and GnRH-II induce cell growth inhibition in human endometrial cancer cells: involvement of integrin beta3 and focal adhesion kinase. Reprod Biol Endocrinol 7:81.
35. Raghu H, Gondi C S, Dinh D H, Gujrati M, & Rao J S (2011) Specific knockdown of uPA/uPAR attenuates invasion in glioblastoma cells and xenografts by inhibition of cleavage and trafficking of Notch -1 receptor. Mol Cancer 10:130.
36. Pawlak K, Ulazka B, Mysliwiec M, & Pawlak D (2012) Vascular endothelial growth factor and uPA/suPAR system in early and advanced chronic kidney disease patients: a new link between angiogenesis and hyperfibrinolysis? Transl Res.
37. Wen P Y, Lee E Q, Reardon D A, Ligon K L, & Alfred Yung W K (2012) Current clinical development of P13K pathway inhibitors in glioblastoma. Neuro Oncol 14(7):819-829.
38. Waugh M G (2012) Phosphatidylinositol 4-kinases, phosphatidylinositol 4-phosphate and cancer. Cancer Lett.
39. Jamieson S, et al. (2011) A drug targeting only p110alpha can block phosphoinositide 3-kinase signalling and tumour growth in certain cell types. Biochem J 438(1):53-62.
40. Nakata S, et al. (2012) LGR5 is a marker of poor prognosis in glioblastoma and is required for survival of brain cancer stem-like cells. Brain Pathol.
41. Rossi M, et al. (2011) beta-catenin and Glil are prognostic markers in glioblastoma. Cancer Biol Ther 11(8):753-761.
42. Eyler C E & Rich J N (2008) Survival of the fittest: cancer stem cells in therapeutic resistance and angiogenesis. J Clin Oncol 26(17):2839-2845.
43. Behrens J, et al. (1993) Loss of epithelial differentiation and gain of invasiveness correlates with tyrosine phosphorylation of the E-cadherin/beta-catenin complex in cells transformed with a temperature-sensitive v-SRC gene. J Cell Biol 120(3):757-766.
44. Aikawa T, et al. (2008) Glypican-1 modulates the angiogenic and metastatic potential of human and mouse cancer cells. J Clin Invest 118(1):89-99.
45. Hanahan D & Weinberg R A (2000) The hallmarks of cancer. Cell 100(1):57-70.
46. Bertrand J, et al. (2009) Cancer stem cells from human glioma cell line are resistant to Fas-induced apoptosis. Intl Oncol 34(3):717-727.
47. Calzada M J, et al. (2004) Alpha4beta1 integrin mediates selective endothelial cell responses to thrombospondins 1 and 2 in vitro and modulates angiogenesis in vivo. Circ Res 94(4):462-470.
48. Aoudjit F & Vuori K (2012) Integrin signaling in cancer cell survival and chemoresistance. Chemother Res Pract 2012:283181.
49. Erikstein B K, et al. (1993) Expression of CD18 (integrin beta 2 chain) correlates with prognosis in malignant B cell lymphomas. Br J Haematol 83(3):392-398.
50. Terol M J, et al. (1999) Expression of beta-integrin adhesion molecules in non-Hodgkin's lymphoma: correlation with clinical and evolutive features. J Clin Oncol 17(6):1869-1875.
51. Lathia J D, et al. (2010) Integrin alpha 6 regulates glioblastoma stem cells. Cell Stem Cell 6(5):421-432.
52. Velpula K K, et al. (2012) Glioma stem cell invasion through regulation of the interconnected ERK, integrin alpha6 and N-cadherin signaling pathway. Cell Signal.
53. Friedrichs K, et al. (1995) High expression level of alpha 6 integrin in human breast carcinoma is correlated with reduced survival. Cancer Res 55(4):901-906.
54. Akasaki Y, et al. (2006) A peroxisome proliferator-activated receptor-gamma agonist, troglitazone, facilitates caspase-8 and -9 activities by increasing the enzymatic activity of protein-tyrosine phosphatase-1B on human glioma cells. J Biol Chem 281(10):6165-6174.
55. Evangelisti C, et al. (2009) MiR-128 up-regulation inhibits Reelin and DCX expression and reduces neuroblastoma cell motility and invasiveness. FASEB J 23(12):4276-4287.
56. Becker J, Frohlich J, Perske C, Pavlakovic H, & Wilting J (2012) Reelin signalling in neuroblastoma: Migratory switch in metastatic stages. Intl Oncol 41(2):681-689.
57. Brule S, et al. (2009) Glycosaminoglycans and syndecan-4 are involved in SDF-1/CXCL12-mediated invasion of human epitheloid carcinoma HeLa cells. Biochim Biophys Acta 1790(12):1643-1650.
58. Huang W, Chiquet-Ehrismann R, Moyano J V, Garcia-Pardo A, & Orend G (2001) Interference of tenascin-C with syndecan-4 binding to fibronectin blocks cell adhesion and stimulates tumor cell proliferation. Cancer Res 61(23):8586-8594.
59. Ridgway L D, Wetzel M D, & Marchetti D (2010) Modulation of GEF-H1 induced signaling by heparanase in brain metastatic melanoma cells. J Cell Biochem 111(5):1299-1309.
60. Naganuma H, et al. (2004) Quantification of thrombospondin-1 secretion and expression of alphavbeta3 and alpha3beta1 integrins and syndecan-1 as cell-surface receptors for thrombospondin-1 in malignant glioma cells. J Neurooncol 70(3):309-317.
61. Xu Y, Yuan J, Zhang Z, Lin L, & Xu S (2012) Syndecan-1 expression in human glioma is correlated with advanced tumor progression and poor prognosis. Mol Biol Rep.
62. lonov Y, Peinado M A, Malkhosyan S, Shibata D, & Perucho M (1993) Ubiquitous somatic mutations in simple repeated sequences reveal a new mechanism for colonic carcinogenesis. Nature 363(6429):558-561.
63. Smyrk T C, Watson P, Kaul K, & Lynch H T (2001) Tumor-infiltrating lymphocytes are a marker for microsatellite instability in colorectal carcinoma. Cancer 91(12):2417-2422.
64. Oommen S, Gupta S K, & Vlahakis N E (Vascular endothelial growth factor A (VEGF-A) induces endothelial and cancer cell migration through direct binding to integrin {alpha}9{beta}1: identification of a specific {alpha}9{beta}1 binding site. J Biol Chem 286(2):1083-1092.
65. Koch A E, et al. (1992) Interleukin-8 as a macrophage-derived mediator of angiogenesis. Science 258(5089):1798-1801.

### Example 2

### Illustrative Method, Data and Results

Data and Preprocessing

GBM mRNA expression data was downloaded from TCGA data portal on April 2011²¹. To reduce batch effects of arrays and protocols, only data from Agilent G4502A arrays measured at the UNC medical school were used, yielding 455 samples, 10 of which were from normal tissue. Additionally, 228 glioblastoma samples and 28 normal brain samples were obtained from REMBRANDT²³. Subtypes classification was taken from Veerhak et al.²⁵ Classification of the REMBRANDT data and additional TCGA samples was done using the same genes. Colorectal mRNA data was taken from Sheffer et al.⁴¹ which contains 313 samples including normal tissue (52 samples), polyps (49), primary tumors (182) and metastases from the liver (21) and lung (9); Sveen et al.⁴⁴ containing 13 normals and 76 primary tumors of stages 2,3 (one tumor sample was removed); and Kogo et al.⁴⁵ containing 9 normal and 132 primary tumors of all stages.

For TCGA data level 3 already processed data was used and for Kogo data the downloaded processed data was used. For all the rest, data was summarized with PLIER and normalized with cyclic LOWESS⁶³. To eliminate noisy genes only the 5000 most varying genes for each cancer type (sum of variation on all 2 or 3 datasets) were selected for further analysis.

Assembly of Pathway Associated Gene Sets

Gene sets were imported from three pathway databases, KEGG^{16,17}, BioCarta¹⁸ (both downloaded from MSigDB⁶⁴) and the NCI-Nature curated Pathway Interaction Database¹⁹. Identity of genes in gene sets was decided according to their official gene symbols. Gene sets with less than 3 genes varying in the data were omitted, leaving 173 KEGG pathways, 188 BioCarta pathways and 197 NCI-Nature PID pathways.

Chromosomal Instability Index

Chromosomal instability index (CIN) was deduced from gene expression, following reference⁴¹. For a given tumor sample, each chromosomal arm was scored as follows. For every gene i calculate fcᵢ the fold change versus the median expression of the gene in the normal samples. The median fold change of the chromosomal arm a is defined as

$$CIN = {\sum }_{a} {fc}_{a}^{2} .$$

The total chromosomal instability index is the sum (over all arms) of the squared median fold changes

$${fc}_{a} = {median}_{i ∈ a} {fc}_{i} .$$

Spearman correlation between the CIN index and the deregulation score of every pathway was calculated across each colorectal dataset. The list of pathways passing 5% FDR was recorded for every dataset. The Fisher exact test was applied to evaluate the significance of the similarity between every pair of pathway lists.

Implementation and Availability

The code is implemented in R and Fortran based on “princurve 1.1-10” by Andreas Weingessel (http://cran.r-project.org/web/packages/princurve/index.html), which is in turn based on the original S/Fortran code princury by Hastie.

Results

Brief Outline of the Above Described Method

The above described method analyzes N_{P} pathways, one at a time, and assigns to each sample i and pathway P a score D_{P}(i), which estimates the extent to which the behavior of pathway P deviates, in sample i, from normal. To determine this pathway deregulation score (PDS), the expression levels of those d_{P} genes that belong to P (e.g. using databases such as¹⁶⁻¹⁹) were used. Each sample i is a point in this d_{P} dimensional space; the entire set of samples forms a cloud of points, and the “principal curve”²⁰, that captures the variation of this cloud was calculated. Next each sample was projected onto this curve; the PDS is defined as the distance D_{P}(i), measured along the curve, of the projection of sample i, from the projection of the normal samples (see FIG. 1). On the basis of genome-wide gene-level expression data a pathway-level, biologically relevant N_{P}-dimensional representation of each sample was generated, and mine this representation for insights. The above described method allows integration of external (partial and approximate) information on the samples, such as tumor stage, grade, chromosomal instability, survival, etc. (see the section below entitled “Detailed exemplary description for determining the analysis”).

The PDS capture biologically relevant information in glioblastoma

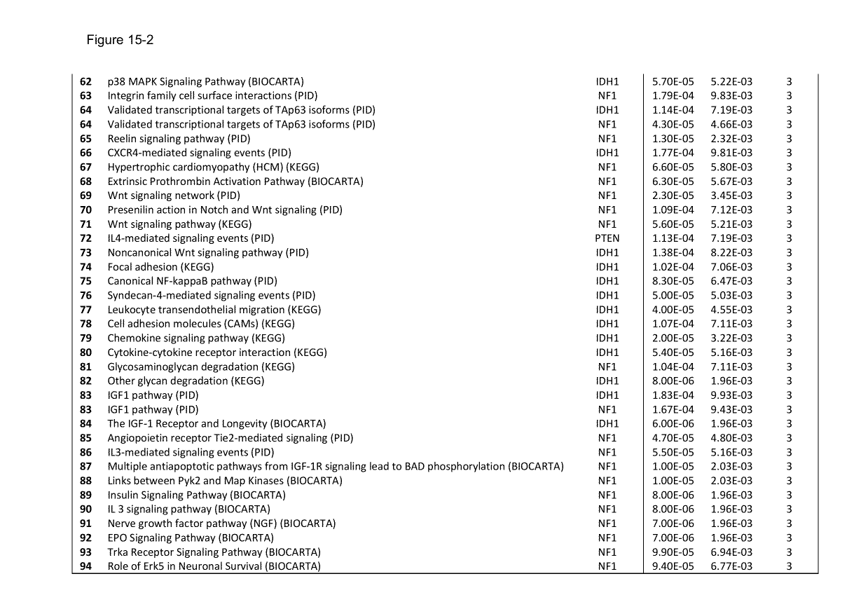

The above described method was applied to expression data from 445 glioblastoma multiforme (GBM) and 10 normal brain samples from The Cancer Genome Atlas (TCGA)²¹. The PDS for 548 pathways from KEGG^{16,17}, BioCarta¹⁸ and the NCI-Nature Pathway Interaction Database¹⁹ are presented in a 548 by 455 table (FIG. 2A), representing the deregulation score of each pathway in every sample and summarized in FIG. 2B. For 135 of the 445 tumors, TCGA identified point mutations in key genes. Ten genes (EGFR, PIK3R1, IDH1, ERBB2, DST, SYNE1, NF1, RB1, PTEN, TP53) were mutated in more than 5% of the samples; 96 of the 135 sequenced samples had mutations in one or more of these genes. 94 pathways are significantly related to a mutation (Mann-Whitney, FDR<1%). These 94 pathways are partitioned, on the basis of their PDS, into 3 clusters (FIG. 2C, Table 1 and FIG. 15).

TABLE 1
Pathways predicting survival in both glioblastoma datasets.
Significant agreement was found between the pathways
that predict survival. Pathways were identified by logrank
p-value, with FDR < 10% for each dataset.

| | | | Rem- | Rem- |
|---|---|---|---|---|
| | TCGA | CGA | brandt | brandt |
| Pathway | p-value | FDR | p-value | FDR |
| BIOCARTA: Agrin in | 9.25E−03 | .083 | 2.45E−02 | 0.084 |
| Postsynaptic Differentiation | | | | |
| BIOCARTA: ALK pathway | 1.79E−03 | .074 | 1.42E−03 | 0.015 |
| BIOCARTA: Fibrinolysis | 1.47E−03 | .074 | 6.71E−03 | 0.039 |
| Pathway | | | | |
| BIOCARTA: Growth Hormone | 7.47E−03 | .083 | 4.35E−03 | 0.029 |
| Signaling Pathway | | | | |
| BIOCARTA: Regulation of | 1.00E−03 | .074 | 3.05E−02 | 0.094 |
| hematopoiesis by cytokines | | | | |
| KEGG: Alpha linolenic acid | 8.89E−03 | .083 | 2.26E−04 | 0.007 |
| metabolism | | | | |
| KEGG: ARVC | 1.06E−02 | .090 | 1.90E−03 | 0.018 |
| KEGG: Basal cell carcinoma | 9.17E−03 | .083 | 7.78E−04 | 0.010 |
| KEGG: ERBB signaling | 6.37E−03 | .077 | 1.94E−02 | 0.074 |
| pathway | | | | |
| KEGG: FcεRI signaling | 9.38E−03 | .083 | 2.73E−05 | 0.004 |
| pathway | | | | |
| KEGG: Focal adhesion | 9.38E−03 | .083 | 3.35E−04 | 0.008 |
| KEGG: GnRH signaling | 6.60E−03 | .077 | 8.39E−05 | 0.004 |
| pathway | | | | |
| KEGG: Inositol phosphate | 5.33E−03 | .077 | 1.86E−02 | 0.072 |
| metabolism | | | | |
| KEGG: Insulin signaling | 3.07E−03 | .074 | 6.55E−03 | 0.039 |
| pathway | | | | |
| KEGG: Long-term depression | 4.77E−03 | .077 | 5.21E−04 | 0.009 |
| KEGG: MAPK signaling | 1.37E−02 | .099 | 1.14E−02 | 0.051 |
| pathway | | | | |
| KEGG: Prostate cancer | 1.07E−02 | .090 | 3.79E−04 | 0.008 |
| KEGG: Vibrio cholerae | 3.54E−03 | .074 | 7.84E−05 | 0.004 |
| infection | | | | |
| KEGG: WNT signaling pathway | 3.91E−03 | .074 | 1.14E−02 | 0.051 |
| PID: E-cadherin stabilization | 4.94E−03 | .077 | 2.96E−03 | 0.024 |
| pathway | | | | |
| PID: Glypican 1 network | 9.14E−03 | .083 | 8.70E−05 | 0.004 |
| PID: HIF2α (EPAS1) | 1.15E−02 | .092 | 1.99E−02 | 0.074 |
| transcription factor network | | | | |
| PID: HIV1NEF- Negative | 2.61E−03 | .074 | 5.52E−03 | 0.035 |
| effector of Fas and TNF-alpha | | | | |
| PID: Insulin-mediated glucose | 1.20E−02 | .094 | 1.40E−02 | 0.060 |
| transport | | | | |
| PID: α4β1 integrin signaling | 1.08E−02 | .090 | 1.84E−02 | 0.072 |
| events | | | | |
| PID: β2 integrin cell surface | 2.26E−03 | .074 | 2.72E−03 | 0.024 |
| interactions | | | | |
| PID: α6β4 integrin-ligand | 5.60E−03 | .077 | 3.41E−03 | 0.026 |
| interactions | | | | |
| PID: Direct p53 effectors | 6.42E−03 | .077 | 1.82E−02 | 0.072 |
| PID: PDGFRβ signaling | 3.83E−03 | .074 | 2.92E−03 | 0.024 |
| pathway | | | | |
| PID: Signaling events | 1.18E−02 | .094 | 1.25E−03 | 0.015 |
| mediated by PTP1B | | | | |
| PID: Reelin signaling pathway | 4.19E−03 | .077 | 1.59E−02 | 0.065 |
| PID: RET tyrosine kinase | 3.69E−03 | .074 | 8.40E−05 | 0.004 |
| signaling | | | | |
| PID: Syndecan-4-mediated | 6.48E−03 | .077 | 2.99E−02 | 0.093 |
| signaling events | | | | |
| PID: Validated transcriptional | 5.79E−04 | .074 | 1.03E−02 | 0.048 |
| targets of TAp63 isoforms | | | | |
| PID: Signaling events mediated | 3.78E−03 | .074 | 1.65E−04 | 0.006 |
| by VEGFR1 and VEGFR2 | | | | |

Pathways of cluster P1 are deregulated mostly in samples of cluster S2, which comprises tumors with IDH1 mutation. All 32 pathways in P2 are activated by EGF signaling. Indeed, they are highly deregulated on sample cluster S5, which includes almost all patients with EGFR mutations. The fact that the scores capture the deregulation of EGF signaling pathways, expected in samples with oncogenic EGF mutations²², is reassuring and indicates that the method indeed captures relevant biological information. Another example of concordance of PDS with mutations is of cluster P3, which contains many pathways with high PDS in tumors with NF1 mutations (mostly in sample cluster S4), and low PDS in tumors with IDH1 mutation (mostly in S2). Another indication of the biological relevance of the PDS is the observed correlation of the scores of many cell death-related pathways with the necrosis levels of GBM samples (see FIG. 16 and the section entitled “Detailed exemplary description for determining the analysis”).

PDS-Based Stratification of Glioblastoma

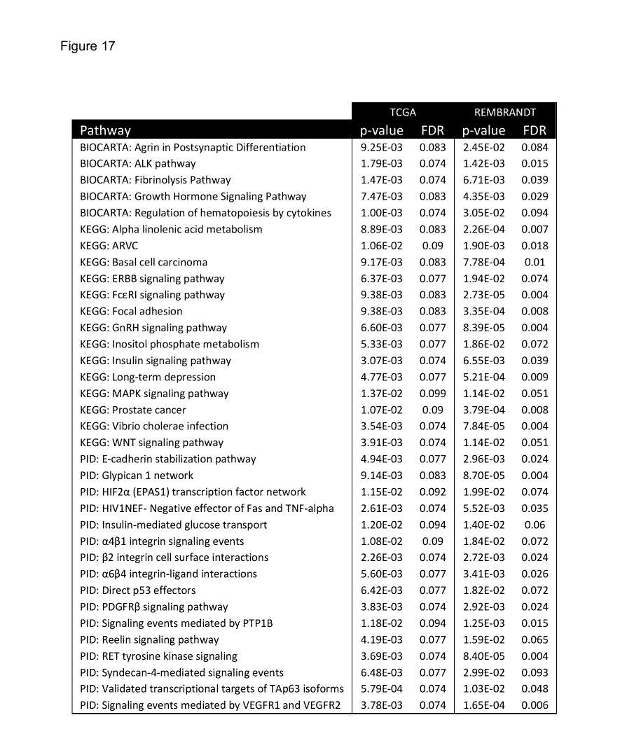

Hierarchical average-linkage clustering according to PDS of the TCGA data (FIG. 2A) generates (a) sample clusters, which are consistent with known classification and extend it, and (b) pathway clusters, with related biological functions. The Normal samples form cluster TgS7; Mesenchymal tumors comprise clusters TgS1-3 (and the small cluster TgS11); Classical cancers are in TgS8-9, while Neurals and Proneurals in TgS12-16. The main pathway types that form each pathway cluster are indicated to the right of FIG. 2A. For more details see the section entitled “Detailed exemplary description for determining the analysis” and FIG. 17.

A concise representation of the characteristic deregulation profiles of the sample types over the pathway clusters, given in the left part of FIG. 2B, reveals further, more subtle, sub-stratification of the tumors. Most Mesenchymal samples are in clusters TgS1, TgS2, TgS3 and TgS11, mostly deregulated in pathway clusters TgP8-TgP16. The main differences between the sub-types are (a) no deregulation of TgP7-TgP9 pathways in the samples of TgS2; (b) deregulation of TgP2 in TgS3 and (c) of TgP4 pathways in TgS11. TgS11 and TgS4 contain Classical-like Mesenchymals and Mesenchymal-like Classicals—these intermediate tumor types are deregulated on both the typical Mesenchymal pathway clusters TgP8-TgP15 and the characteristic Classical TgP4 and TgP5. The emergence of this “sub-class” might be due to heterogeneous samples containing both types of cells, or to a new subtype with Classical and Mesenchymal features. The Neural and Proneural samples appear in 9 clusters, mostly in TgS12-TgS16. Some Neural/Proneural tumors, of TgS13 and TgS15, are normal-like and are not deregulated on most pathways.

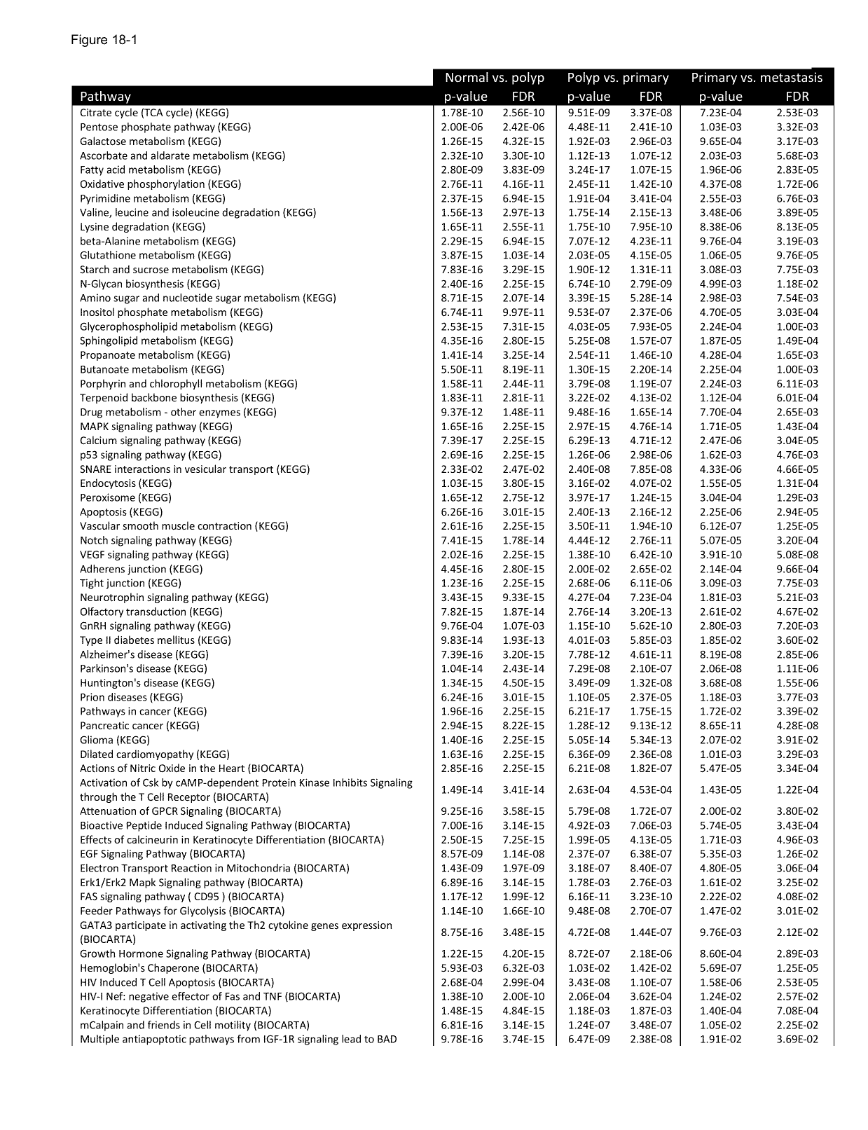

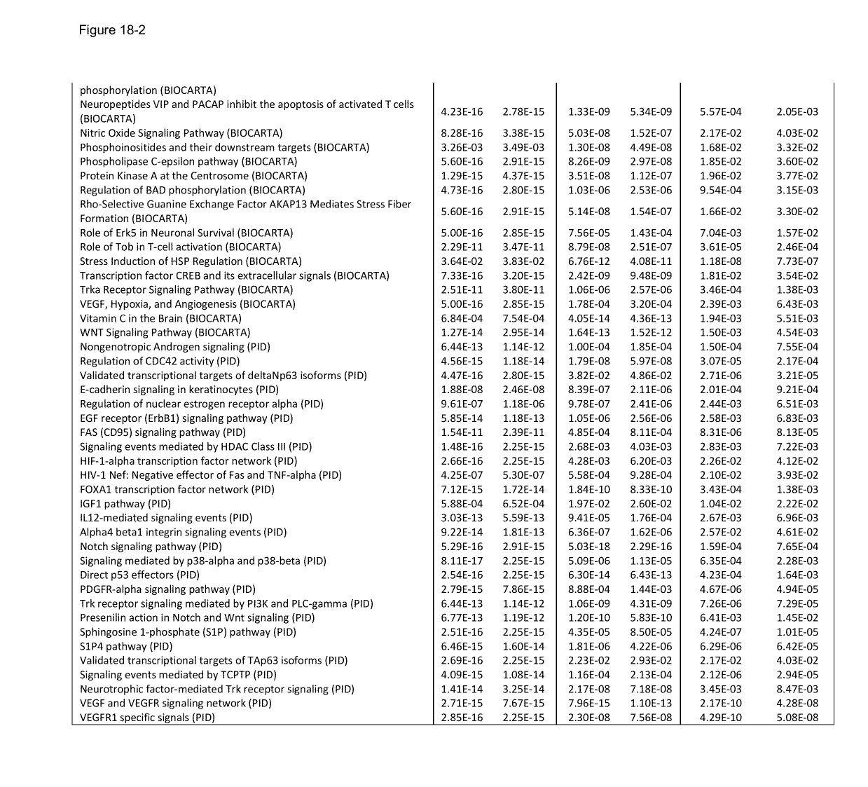

To validate these results data was used from REMBRANDT (REpository for Molecular BRAin Neoplasia DaTa)²³. The clustering results are shown in FIG. 2D and FIG. 18, and summarized in the right of FIG. 2B. Fisher's exact test (p<0.05) identified correspondence between pathway clusters found in the TCGA data and in REMBRANDT (marked ReP); the main PDS-based features and results are mostly reproduced (see FIG. 2B and the section entitled “Detailed exemplary description for determining the analysis”).

The Pathway Based Sub-Stratification of GBM has Important Clinical Implications

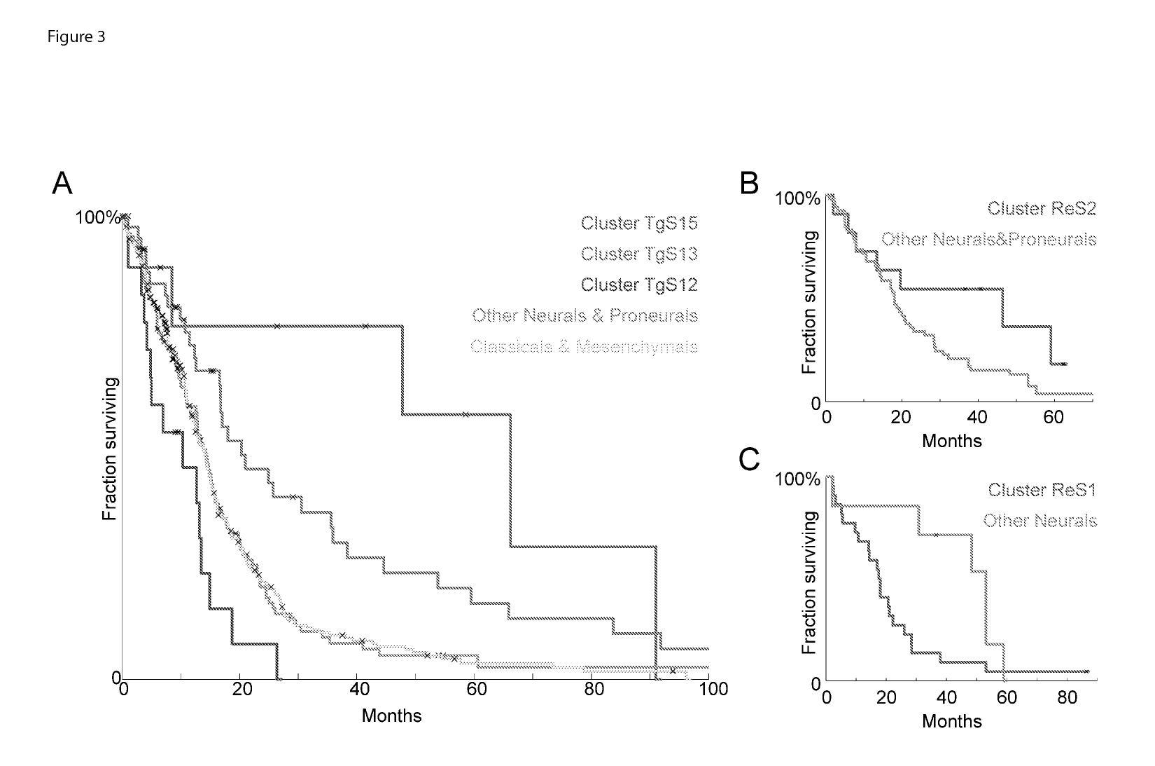

Neural and Proneural samples are thought to have better prognosis^{24,25}; the pathway based sub-stratification reveals, however, that this notion is due to a subset of better survivors (logrank p-value²⁶<0.05). In the TCGA data, patients of clusters TgS15 and TgS13, which have relatively few deregulated pathways, survive significantly longer than other Neural and Proneural samples (p=0.009 for TgS15 and p=0.015 for TgS13), while patients from TgS12 have worse prognosis (p=0.003) as can be seen in FIG. 3A. If this group of good survivors is removed from the Neural and Proneural samples, the remaining patients of these classes do no better than patients with Mesenchymal and Classical tumors. The separation between survival of the patients of TgS12,13,15 remains significant even if the comparison is made only for the Proneural samples.

These results are reproduced on the REMBRANDT data as well—patients with Neural or Proneural tumors in cluster ReS2, the one for which only few pathways are deregulated, have better prognosis than other Neurals and Proneurals (p=0.066, FIG. 3B). Cluster ReS1 contains only normals and normal-like Neural samples. Interestingly, these normal-like Neural tumors have worse prognosis than other Neurals (p=0.032, FIG. 3C).

Pathways Associated with Survival in Glioblastoma

77 pathways are significantly related to survival on the TCGA data, and 187 on the REMBRANDT data (FDR<10%, from Kaplan-Meier analysis, comparing the top ⅓ deregulated samples to the bottom ⅓, logrank p-value). 37 of these pathways overlap, constituting a significant intersection (p=0.005). Higher PDS were associated with bad prognosis on both datasets for all but two pathways (which are probably false positives, as higher deregulation implies worse prognosis on REMBRANDT but better on TCGA). Many of the other 35 pathways, listed in Table 1, make biological sense: Some are related to angiogenesis, critical to glioblastoma progression (such as VEGF signaling, Fibrinolysis, PDGFRβ signaling, α4β1 integrin signaling, HIF2α pathway); Many are known key players in glioblastoma and cancer in general, are known to have a prognostic value, and are promising drug targets (such as MAP kinase²⁷⁻³¹, Insulin signaling and its components³²⁻³⁴, RET tyrosine kinase³⁵, EGFR/ERBB signaling³⁶, PDGF signaling³⁷ and integrins³⁸). For the full list of other survival-related pathways and their roles in glioblastoma see the section entitled “Detailed exemplary description for determining the analysis”.

Comparison of the Inventive Method, in at Least Some Embodiments, with PARADIGM

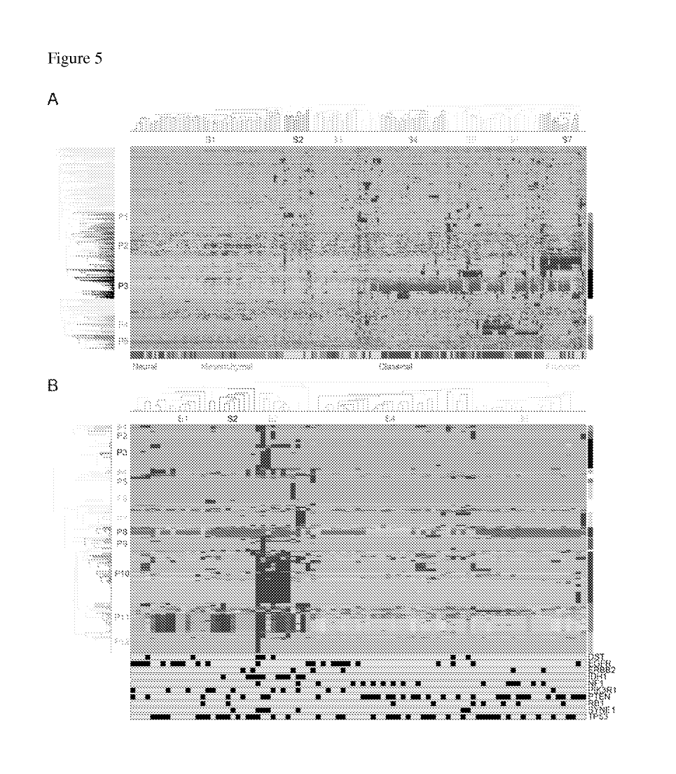

The analyses were repeated using the scores derived using PARADIGM. EGFR gene and EGFR complexes were indeed found to be correlated to EGFR mutations as expected (FDR<1%). However, no pathways were found to be correlated to the EGFR mutations. Not much more could be inferred by the analysis based on PARADIGM scores analysis (FIG. 5). As reported in¹⁵, some stratification of glioblastoma is possible by PARADIGM IPA's, but it does not match strongly the known subtypes. Though it did successfully detect a relevant cluster of HIF1A low and E2F high tumors, PARADIGM missed many of the observations mentioned above. None of the IPA's is found to be related to survival with FDR of 19% or less. Therefore although PARADIGM is a very useful method to integrate different types of data and deduce simple complexes and downstream activations (such as EGF receptor activation), the above described method provides additional clinically relevant and easy to interpret information about the deregulation of complex pathways.

Pathway Deregulation in Colorectal Cancer is Associated with Chromosomal and Micros Atellite Instability

Two kinds of genetic instabilities were identified in colon cancer: chromosomal instability (CIN) and microsatellite instability (MSI-high). CIN tumors exhibit abnormal numbers of chromosomes, deletions and amplifications of smaller genomic regions and translocations. CIN tumors constitute 85% of colon cancers, tend to have p53 mutations³⁹⁻⁴¹ and tend to originate in the distal (left) colon⁴². MSI-high tumors have highly varying lengths of short sequences of nucleotides, caused by dysfunctional mismatch-repair genes. These tumors account for 15% of the colon cancer cases⁴³, usually display no large-scale deletions and amplifications and originate in the proximal (right) colon⁴². High CIN tumors are usually microsattelite stable (MSS).

The above described method was applied to expression data of Sheffer et al.⁴¹ (313 samples of normal colon, polyps, primary carcinoma and metastases), and validated the results on datasets of Sveen et al⁴⁴ and Kogo et al⁴⁵ (89 and 141 samples, respectively; see Methods).

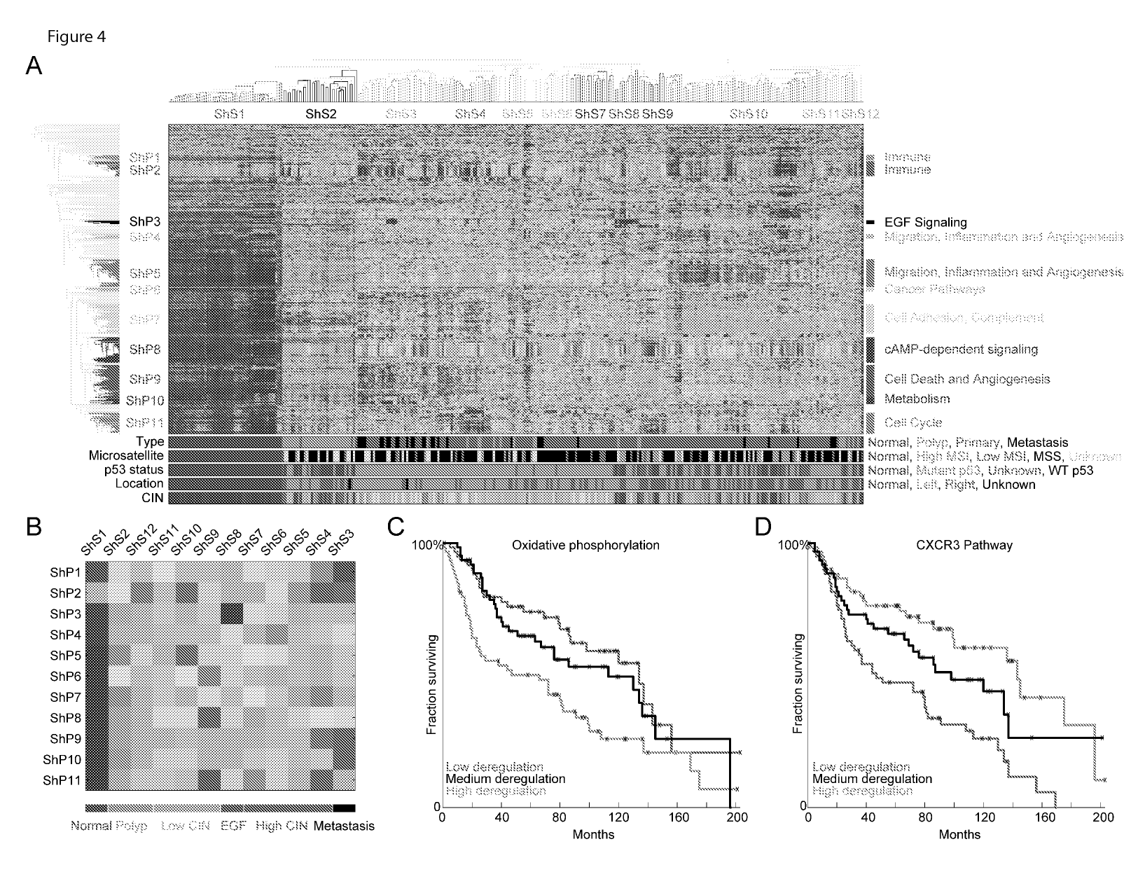

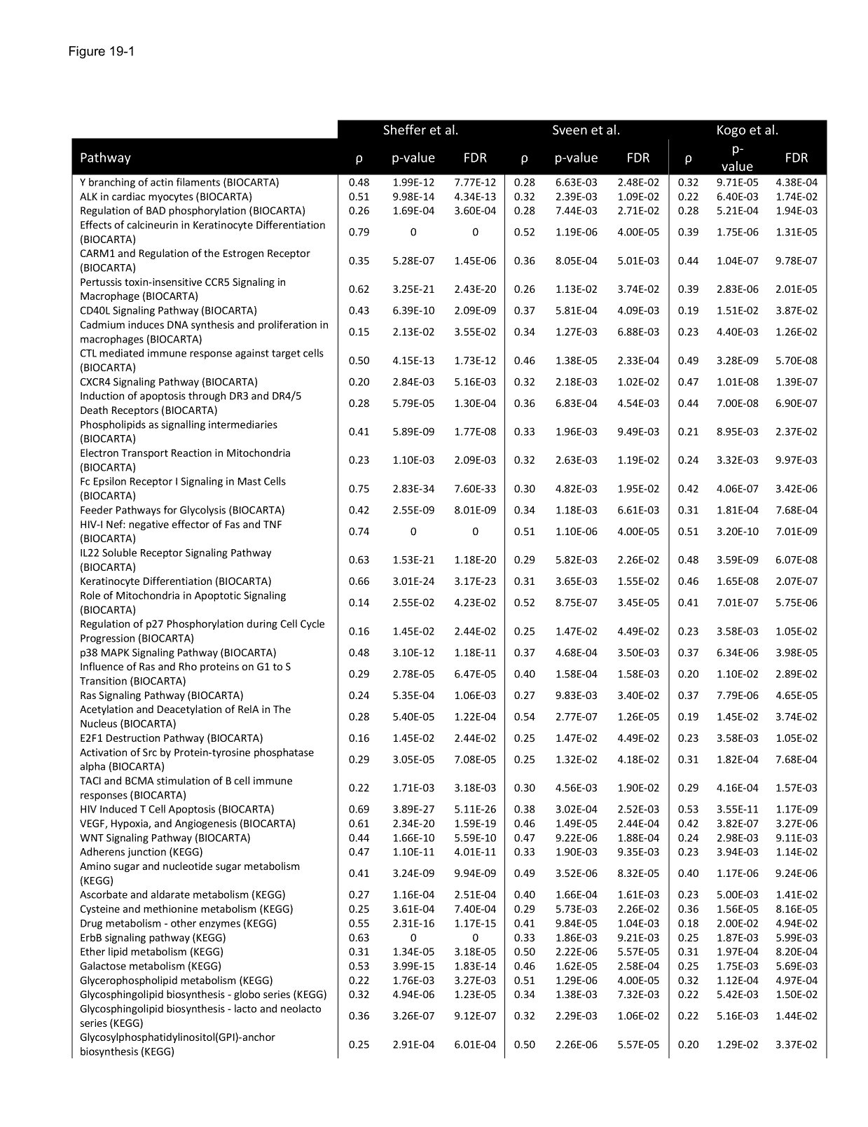

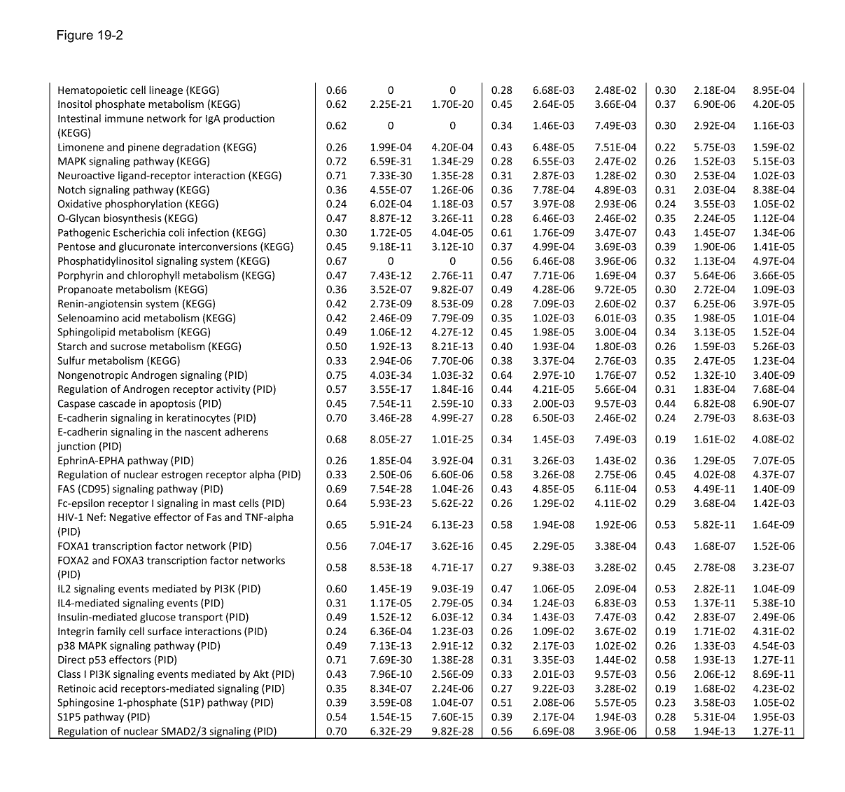

Notably, for many relevant pathways the PDS reflected disease progression (see FIGS. 1 and 4). 106 pathways showed increased deregulation with disease progression, i.e. significant (Mann-Whitney, 5% FDR) and consistent in all three transitions tested: from normals to polyps, polyps to primary and primary tumors to metastasis (FIG. 19). The deregulation scores of many pathways are correlated with the level of chromosomal instability within the tumor, as measured by the CIN index (see Methods). This correlation also reflected the differences between MSI-high (mostly low CIN) and MSS (high CIN) subtypes (see the section entitled “Detailed exemplary description for determining the analysis”). 84 pathways show increasing deregulation with increase of the CIN index, in all three datasets (see FIG. 20 and the section entitled “Detailed exemplary description for determining the analysis”). This number of shared pathways correlated to CIN in all three datasets is highly significant (p<4×10⁻⁴ for every pair). These 84 include many metabolic pathways, Death pathways (Induction of apoptosis, T-cell apoptosis, BAD phosphorylation, caspase cascade, FAS signaling, etc.); Signaling pathways that are often deregulated in cancer (many of KEGG's “cancer pathways”, PI3K, p53, VEGF, WNT, ERBB, Notch, SRC, etc.). 31 of the 84 pathways (37%) exhibit increased deregulation with progression, as defined above.

Many pathways are differentially deregulated between MSS and MSI-high tumors (325 pathways in the Sheffer dataset, with significant overlap to those in the Sveen data, p=1.92×10⁻⁵ for MSS deregulated pathways, p=0.022 for MSI-high, Fisher exact test; see the section entitled “Detailed exemplary description for determining the analysis” and FIG. 11). The pathways that were highly deregulated in MSI-high tumors, in both datasets, included the mismatch repair pathway and pathways related to immune response. This is reassuring, since MSI-high tumors are known to have defective mismatch repair⁴³ and are usually characterized by higher levels of inflammation and tumor infiltrating lymphocytes⁴⁶. Pathways downstream of p53 were highly deregulated in MSS tumors, where p53 mutations are frequent, whereas in MSI-high, many pathways upstream of p53 are deregulated.

Pathway Deregulation Based Stratification of Colorectal Cancer

Clustering analysis of the deregulation scores of the Sheffer data identified 11 pathway clusters (denoted by ShP1-ShP11) and 12 sample clusters (ShS1-ShS12) (see FIG. 4A, FIG. 19, the section entitled “Detailed exemplary description for determining the analysis”). The normal samples comprise cluster ShS1; the polyps -ShS2 (and ShS12); metastatic samples belong mainly to ShS3. High CIN primary tumors belong to clusters ShS3-ShS7 and ShS11. These samples are located mainly at the distal part of the colon and are mostly MSS. Clusters ShS8-ShS10 are associated with lower CIN levels, showing mixed locations. Clusters ShS9 and ShS10 include most of the low-CIN, MSI-high samples, and cluster ShS8 is associated with EGF deregulation.

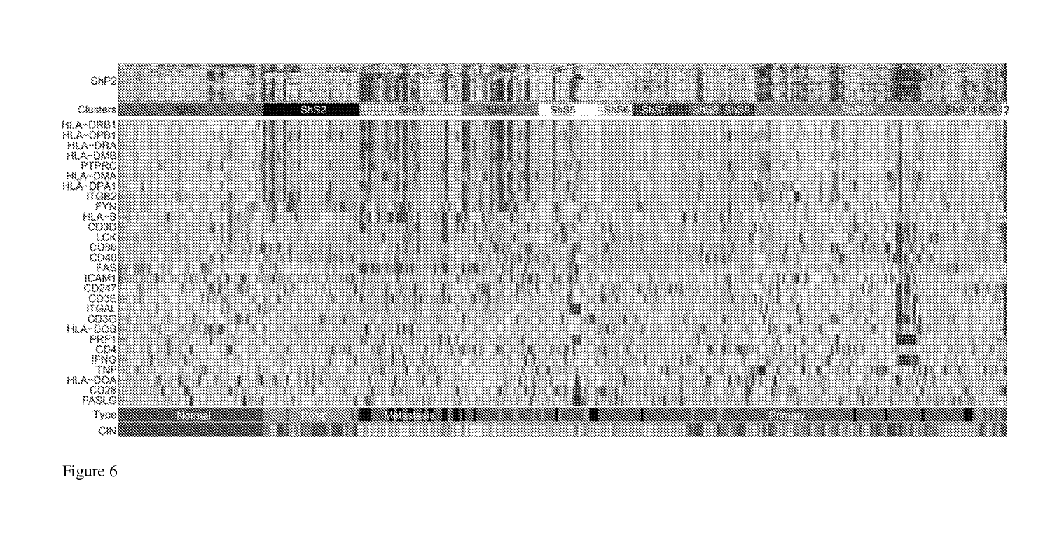

Sub-stratifications of the samples emerge from the clustering, as can be noticed from FIG. 4B, displaying a concise coarse-grained representation of the characteristic deregulation profiles. Clusters ShP1 and ShP2 (related to the immune response) are deregulated on a subset of the polyps. Interestingly, normals have a mid-level score on ShP2: Tumors (and polyps) can deviate along two distinct routes from the normals. Samples in ShS10-12 have lower-than-normal (negative) scores, while those of ShS3-ShS5 get positive PDS. As shown in FIG. 6, negative PDS correspond to high expression levels of HLA class II molecules and T- and B-cell receptors, which are responsible for activation of the immune response, and hence are indicative of high levels of tumor infiltrating lymphocytes.

A new class of colon cancer was discovered, characterized by high deregulation of cluster ShP3, which contains EGF signaling pathways, including EGF, EGFR and ERBB signaling. This cluster is markedly deregulated in ShS8, is comprised of 9 tumors and 2 polyps. The main cause of the deregulation is over-expression of EGF; no prior identification of such a subgroup has been made, even though there are some reports of EGFR mutations in colon cancer⁴⁷, Apparently about 5% of the tumors belong to this class; hence relatively large cohort is needed to observe them. Identification of mutations or amplifications associated with these tumors may provide a new therapeutic strategy that targets the EGF pathway.

Clusters ShP4 and ShP5 (containing pathways known to play a role in cell migration and invasion^{48,49}) show marked deregulation in most samples of ShS10. Deregulation of pathways from cluster ShP5 defines a new subgroup of low-CIN tumors (ShS10), that contains both MSS and MSI-high samples, and hence is probably independent of the MSI status; the survival rates of this cluster are not different than those of the high CIN groups. Clusters ShP6, ShP7, ShP9 and ShP10 show high deregulation in the high CIN clusters ShS3-4; see FIG. 19 and the section entitled “Detailed exemplary description for determining the analysis” for details of the pathways of these clusters. Clusters ShP8 and ShP11 are deregulated in different groups of tumors, independent of their CIN level. Many of the pathways that show increase of PDS with progression of the disease (see above) belong to ShP8-10, suggestive of their role in cancer initiation and development.

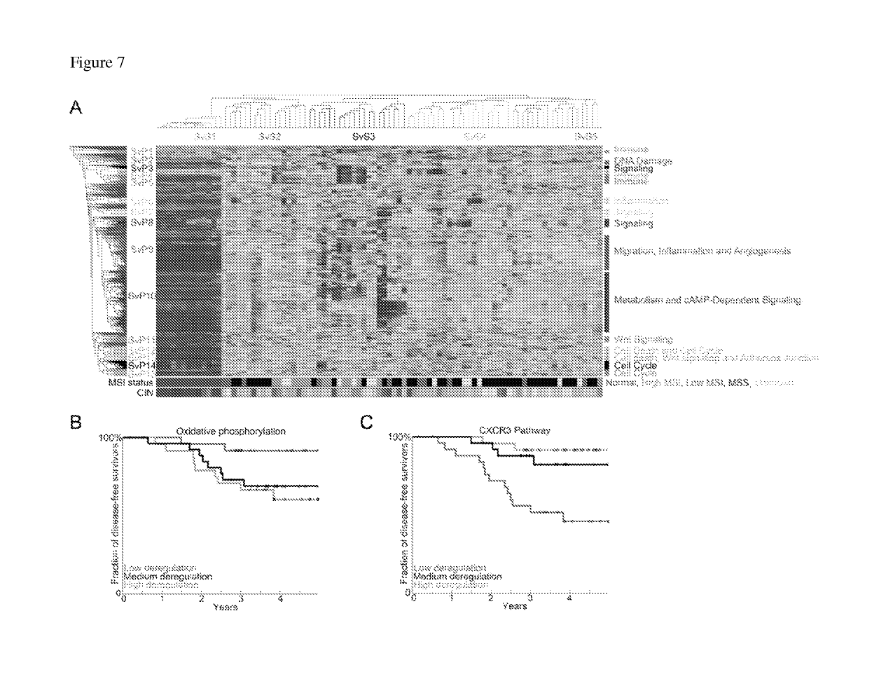

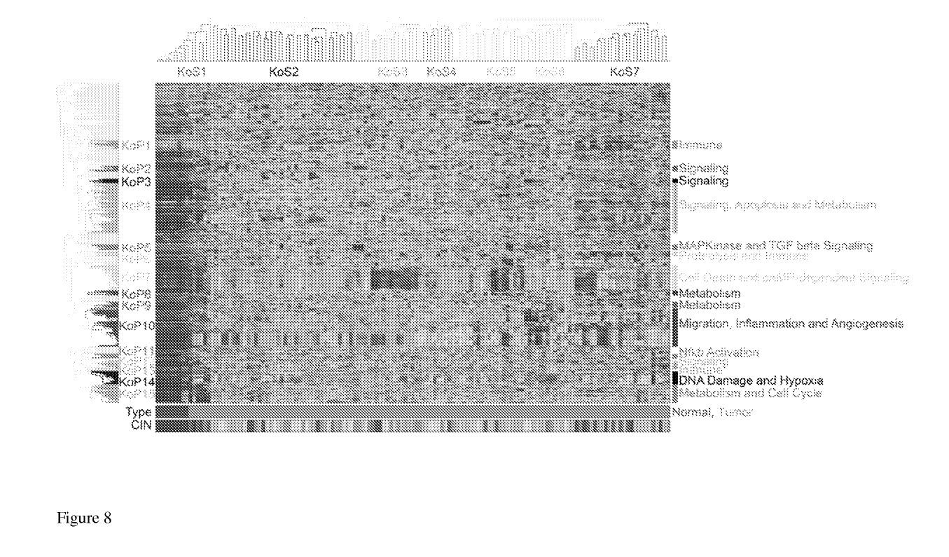

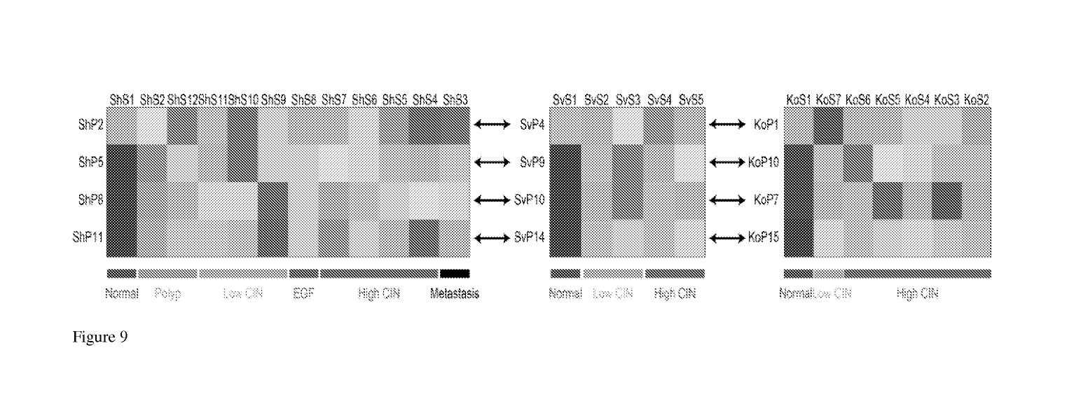

The results of clustering the Sveen and Kogo datasets are shown in FIGS. 7-8, and in FIG. 19. Some of the pathway clusters show significant overlap between all three data sets (Pairwise Fisher exact test, FDR<1%), as shown in FIG. 9 and in FIG. 19. Raising the FDR threshold to 10% doesn't add additional clusters shared by all three datasets. Even though comparison is hindered by the relatively low numbers of samples in these two datasets and their different sample compositions, it was possible to validate several aspects of the tumor stratification of the Sheffer dataset. The immune cluster ShP2 overlaps with clusters SvP4 and KoP1; all three show consistent bi-modal deviations of deregulation from normals. ShP5 (migration, inflammation and angiogenesis) overlaps with SvP9 and KoP10. These clusters have high PDS in low CIN tumors in all three datasets (see FIG. 9). The cluster ShP8 (cAMP dependent signaling) overlaps with SvP10 and KoP7, and ShP11 (cell cycle) with SvP14 and KoP15.

Survival Analysis of Pathways in Colorectal Cancer

13 pathways are significantly related to survival in the Sheffer data (FDR<10%, comparing primary tumors with the top ⅓ deregulation scores to the bottom ⅓, logrank p-value). Three of these pathways are significantly associated with disease-free survival in the Sveen dataset (p<0.01, Kogo et al didn't provide survival information).

The first is oxidative phosphorylation (logrank p-value<1.98×10⁻³ for Sheffer, p<0.027 for Sveen, FIG. 4C and FIG. 7B). Deletions of genomic regions enriched by oxidative phosphorylation genes were previously associated with survival and disease progression⁴¹. Altered mitochondrial respiration in tumors is one of the hallmarks of cancer (Warburg effect⁵⁰). The resulting aneurobic respiration through glycolysis is associated with activation of the hypoxic response of HIF1, which in turn activates angiogenesis, leading to invasion and metastasis.

A new, significant finding is the prognostic value of the CXCR3 pathway—this is a chemokine receptor expressed by activated T-cells and NK cells⁵¹ (p<3.28×10⁻⁵ for Sheffer, p<1.13×10⁻³ for Sveen, FIG. 4D and FIG. 7C). In both datasets, deregulation of the CXCR3 pathway is governed by the expression levels of four chemokine ligands: CXCL11, CXCL10, CXCL9 and CXCL13. All four bind CXCR3^{51,52} and are located at chromosome 4q21. CXCL10 induces migration of T cells and promotes proliferation of recruited T cells, leading to tumor regression⁵³. Forced expression of CXCL11 significantly inhibited tumor growth by recruiting T cells and enhancing immune responses⁵⁴. CXCL13 is a chemokine that binds CXCR5, and high CXCL13 expression levels showed improved outcome in early HER2 positive breast cancer⁵⁵. In the Sheffer and Sveen datasets, these genes are down regulated in tumors with poor outcome, suggesting that higher expression of these ligands is associated with recruitment of T-cells and NK cells that fight the tumor cells and eventually lead to better prognosis of the disease.

The third is the IL22BP pathway, which may play a role in anti-inflammation (p<1.41×10⁻³ for Sheffer, p<0.014 for Sveen). Notably, both oxidative phosphorylation and CXCR3 remained significant in both datasets, even when only MSS and MSI-low tumors were considered (CXCR3, p<2.5×10⁻⁴ Sheffer, p<0.043 Sveen; oxid. Phos. p<7.34×10⁻³ Sheffer, p<0.035 Sveen), suggesting that these pathways are related to survival in colorectal cancer independently of microsatellite stability.

### DISCUSSION

The above described method performs pathway-level analysis of an expression dataset of tumors, and determines for each sample a set of pathway deregulation scores. These PDS are calculated separately for each pathway using genes which are known to take part in its functioning. The approach can be extended to any other kind of data with known pathway assignments, and allows incorporation of an additional parameter that is likely to be correlated with pathway deregulation (chromosomal instability, mutations, etc.). This framework may serve as basis for future integration of different measurements (such as DNA copy number, protein abundance, localization, etc.). The approach is data-based: for each pathway a principal curve was constructed, which captures the variation of the data. All samples are projected onto this curve, and for each sample the distance between this projection and that of the normal samples is measured along the curve. This distance represents the level of deregulation of the pathway. The method copes successfully with the biggest challenges of expression-based pathway analysis: (a) knowledge of biological pathways is partial (b) pathway deregulation is context specific, and (c) available data (e.g. expression) contain only part of the relevant information. By including genes that were labeled by different studies as belonging to a pathway, and using data from the very problem to be studied, it was possible to define a context-specific PDS. This is accomplished without relying on (incompletely known) underlying network connectivity and function, by deducing pathway deregulation from the data itself. The absence of relevant information (e.g. post-translational modifications, protein localization) was handled by projecting the very complex (and unavailable) parameterization of the “biological state” onto expression space, where deregulation is defined by the deviation from the signature of normal samples, measured along a trajectory that reflects context specific deregulation.

The main conceptual aim of defining these scores is to incorporate a large body of prior biological knowledge (in the form of assignment of genes to pathways) to allow further analysis on a “higher” (pathway) level, instead of analyzing directly the expression levels of tens of thousands of genes, in a brute force, “ignorance based” manner.

The method was applied to glioblastoma and colorectal cancer data, and showed that the PDS successfully reflect deregulation of pathways, and constitute a compact and biologically relevant representation of the samples. The resulting representation of the tumors retains most of the essential information present in the original data. Tumors were stratified into subtypes which are easy to interpret in terms of the biologically meaningful and relevant pathways. The resulting tumor groups were consistent with previously identified clinical classes of glioblastoma and colon cancer, and new sub-classes with important clinical consequences were also identified.

For glioblastoma a clinically relevant new sub-stratification of Neural and Proneural samples was determined, separating them into poor and good survivors, as well as a robust new substratification of the Mesenchymal subtype. The method was shown to be robust and the results were validated on additional datasets.

It was shown that important recurrent mutations in glioblastoma have a clear impact on the deregulation scores of the relevant pathways. Some samples without the mutation exhibit similar deregulation profiles to the mutated ones, suggesting alternative equivalent deregulation mechanisms. 35 pathways whose deregulation score is significantly correlated with survival were found, where higher levels of deregulation match poor survival. Some of these pathways (such as MAP kinase) were previously known to be associated with survival in glioblastoma patients, while several others constitute new findings (such as PDGFRβ and WNT signaling), that may serve as new hypotheses for glioblastoma research.

For colorectal cancer it was shown that CXCR3-mediated signaling and oxidative phosphorylation pathways are significantly predictive of survival in two different datasets. Furthermore, a new classification of tumors may be suggested based on their CIN status; high and low, which is broader than the known partition into MSS and MSI-high. Many of the pathways show differential deregulation between these two CIN-based classes of tumors, which cannot be explained solely by their MSI status, emphasizing the important effect of CIN on tumor development. Within the class of low CIN tumors a new subgroup was found, comprised of both MSI-high and MSS, that show high deregulation of pathways related to migration, inflammation and angiogenesis, and indeed these tumors have similar survival rates as the group of high CIN tumors. In addition a novel subclass of tumors was discovered related to aberrant EGF signaling, that comprise about 5% of the patients.

### REFERENCES

1. A. H. Bild, G. Yao, J. T. Chang et al., Nature 439 (7074), 353 (2006).
2. D. C. Thomas, J. W. Baurley, E. E. Brown et al., Cancer Res 68 (24), 10028 (2008).
3. E. K. Markert, H. Mizuno, A. Vazquez et al., Proc Natl Acad Sci USA 108 (52), 21276 (2011).
4. L. M. Heiser, A. Sadanandam, W. L. Kuo et al., Proc Natl Acad Sci USA 109 (8), 2724 (2012).
5. L. Chin, W. C. Hahn, G. Getz et al., Genes Dev 25 (6), 534 (2011).
6. M. P. Cary, G. D. Bader, and C. Sander, FEBS Lett 579 (8), 1815 (2005).
7. I. F. Tsui, R. Chari, T. P. Buys et al., Cancer Inform 3, 379 (2007).
8. S. Efroni, C. F. Schaefer, and K. H. Buetow, PLoS One 2 (5), e425 (2007).
9. A. Mazumder, A. J. Palma, and Y. Wang, Expert Rev Mol Diagn 8 (2), 125 (2008).
10. S. Song and M. A. Black, BMC Bioinformatics 9, 502 (2008).
11. D. Nam and S. Y. Kim, Brief Bioinform 9 (3), 189 (2008).
12. J. Hedegaard, C. Arce, S. Bicciato et al., BMC Proc 3 Suppl 4, S5 (2009).
13. D. C. Thomas, D. V. Conti, J. Baurley et al., Hum Genomics 4 (1), 21 (2009).
14. F. Emmert-Streib and G. V. Glazko, PLoS Comput Biol 7 (5), e1002053 (2011).
15. C. J. Vaske, S. C. Benz, J. Z. Sanborn et al., Bioinformatics 26 (12), i237 (2010).
16. M. Kanehisa and S. Goto, Nucleic Acids Res 28 (1), 27 (2000).
17. M. Kanehisa, S. Goto, Y. Sato et al., Nucleic Acids Res 40 (Database issue), D109 (2012).
18. D. Nishimura, Biotech Software Internet Report 2 (3), 117 (2001).
19. C. F. Schaefer, K. Anthony, S. Krupa et al., Nucleic Acids Res 37 (Database issue), D674 (2009).
20. T. Hastie and W. Stuetzle, J Am Stat Assoc 84 (406), 502 (1989).
21. TCGA, Nature 455 (7216), 1061 (2008).
22. J. C. Lee, I. Vivanco, R. Beroukhim et al., PLoS Med 3 (12), e485 (2006).
23. S. Madhavan, J. C. Zenklusen, Y. Kotliarov et al., Mol Cancer Res 7 (2), 157 (2009).
24. H. S. Phillips, S. Kharbanda, R. Chen et al., Cancer Cell 9 (3), 157 (2006).
25. R. G. Verhaak, K. A. Hoadley, E. Purdom et al., Cancer Cell 17 (1), 98 (2010).
26. R. Peto and J. Peto, Journal of the Royal Statistical Society. Series A (General) 135 (2), 185 (1972).
27. T. Demuth, L. B. Reavie, J. L. Rennert et al., Mol Cancer Ther 6 (4), 1212 (2007).
28. C. Mawrin, S. Diete, T. Treuheit et al., Int J Oncol 23 (3), 641 (2003).
29. A. Glassmann, K. Reichmann, B. Scheffler et al., Int J Oncol 39 (6), 1567 (2011).
30. W. P. Mason, K. Belanger, G. Nicholas et al., J Neurooncol 107 (2), 343 (2012).
31. C. Krakstad and M. Chekenya, Mol Cancer 9, 135 (2010).
32. R. J. Shaw and L. C. Cantley, Nature 441 (7092), 424 (2006).
33. H. B. Newton, Expert Rev Anticancer Ther 4 (1), 105 (2004).
34. M. A. Hildebrandt, H. Yang, M. C. Hung et al., J Clin Oncol 27 (6), 857 (2009).
35. D. S. Krause and R. A. Van Etten, N Engl J Med 353 (2), 172 (2005).
36. U. Andersson, D. Guo, B. Malmer et al., Acta Neuropathol 108 (2), 135 (2004).
37. Y. Dong, L. Jia, X. Wang et al., Intl Oncol 38 (2), 555 (2011).
38. J. S. Desgrosellier and D. A. Cheresh, Nat Rev Cancer 10 (1), 9 (2010).
39. C. Lengauer, K. W. Kinzler, and B. Vogelstein, Nature 396 (6712), 643 (1998).
40. A. Leslie, N. R. Pratt, K. Gillespie et al., Cancer Res 63 (15), 4656 (2003).
41. M. Sheffer, M. D. Bacolod, O. Zuk et al., Proceedings of the National Academy of Sciences 106 (17), 7131 (2009).
42. P. Gervaz, P. Bucher, and P. Morel, J Surg Oncol 88 (4), 261 (2004).
43. Y. lonov, M. A. Peinado, S. Malkhosyan et al., Nature 363 (6429), 558 (1993).
44. A. Sveen, T. H. Agesen, A. Nesbakken et al., Genome Med 3 (5), 32.
45. R. Kogo, T. Shimamura, K. Mimori et al., Cancer Res 71 (20), 6320.
46. T. C. Smyrk, P. Watson, K. Kaul et al., Cancer 91 (12), 2417 (2001).
47. B. Metzger, L. Chambeau, D. Y. Begon et al., BMC Med Genet 12, 144.
48. H. Chung, J. H. Lee, D. Jeong et al., J Biol Chem 287 (23), 19326.
49. K. Y. Na, P. Bacchini, F. Bertoni et al., Pathology 44 (4), 325.
50. P. P. Hsu and D. M. Sabatini, Cell 134 (5), 703 (2008).
51. J. R. Groom and A. D. Luster, Immunol Cell Biol 89 (2), 207.
52. C. H. Jenh, M. A. Cox, W. Hipkin et al., Cytokine 15 (3), 113 (2001).
53. X. Yang, Y. Chu, Y. Wang et al., J Leukoc Biol 80 (6), 1434 (2006).
54. Y. Chu, X. Yang, W. Xu et al., Cancer Immunol Immunother 56 (10), 1539 (2007).
55. E. Razis, K. T. Kalogeras, V. Kotoula et al., Clin Breast Cancer 12 (3), 183.
56. R. Tibshirani, Stat Comput 2 (4), 183 (1992).
57. M. Leblanc and R. Tibshirani, J Am Stat Assoc 89 (425), 53 (1994).
58. C. M. Bishop, M. Svensen, and C. K. I. Williams, Neural Comput 10 (1), 215 (1998).
59. B. Kegl, A. Krzyzak, T. Linder et al., Ieee T Pattern Anal 22 (3), 281 (2000).
60. P. Delicado, J Multivariate Anal 77 (1), 84 (2001).
61. N. Lawrence, J Mach Learn Res 6, 1783 (2005).
62. S. Urbach, MSc Thesis, Weizmann Institute of Science, 2006.
63. K. V. Ballman, D. E. Grill, A. L. Oberg et al., Bioinformatics 20 (16), 2778 (2004).
64. A. Subramanian, P. Tamayo, V. K. Mootha et al., Proc Natl Acad Sci USA 102 (43), 15545 (2005).

### Example 3

### Additional Illustrative Method, Data and Results

The previously described Glioblastoma (GBM) data and results were investigated further. Additional data was also created by another group (Cell 155, 462-477, Oct. 10, 2013, hereby incorporated by reference as if fully set forth herein) which extended the above data in several ways: it added more samples and more molecular information about all the samples. This new data was analyzed as described above.

The new data was used to further analyze one of the above described findings, which was a sub-division of the proneural group of tumors into several clusters with very different survival. One group (TgS15) contained 9 patients with particularly good outcome, and another, TgS12, had 34 samples with very bad outcome. This partition was derived in a completely unsupervised way on the basis of PDS profiling. The newly published data has revealed that 8 out of 9 samples of TgS15 had mutations of the IDH1 gene and a high level of methylation (referred to as G-CIMP in the above paper). No samples of the bad outcome group had either mutated IDH1 or methylation (see Tables 2 and 3 below).

TABLE 2
samples having mutated IDH1

| TgS12 (34) | yes | no |
|---|---|---|
| mut IDH1 | 0 | 31 |
| G-CIMP | 0 | 34 |

TABLE 3
samples showing methylation

| TgS15 (9) | yes | no |
|---|---|---|
| mut IDH1 | 5 | 1 |
| G-CIMP | 8 | 1 |

These results demonstrate the power of the previously described method as straightforward analysis of expression data in the above described paper was unable to identify these clinically meaningful and relevant subgroups.

Robustness of the previously described method was also tested by repeating the analysis over the full dataset of the above paper. In particular the PDS for all patients was derived and then compared with the original classification. Furthermore, data was analyzed that was obtained from two different expression platforms as described in the paper. Even though the number of probes, and genes and the (oligos representing them) of these two microarrays are very different, the resulting PDS profiles of the samples and their stratification were strikingly similar.

Robustness of the method was tested by repeating the analysis over the glioblastoma samples from the above Cell paper as described in the paper Pathway-based personalized analysis of cancer, Drier et al, PNAS 2013, vol. 110 no. 16, pp 6388-6393. In particular the PDS for all patients was derived using expression as measured by two different platforms; Agilent and Affymetrix. The original set of 5000 genes identified as the most variable genes in the Agilent platform was used as a basis for the comparison. For the Affymetrix platform 3328 genes were used from the 5000 genes list (all those genes that were found in Affymetrix probe list). The above described method was applied to both data sets and generated PDS matrices.

FIGS. 22A and 22B present the PDS values for Agilent (FIG. 22A) and Affymetrix (FIG. 22B) with samples and pathways shown in the same order as in FIG. 1A in Pathway-based personalized analysis of cancer, Drier et al, PNAS 2013, vol. 110 no. 16, pp 6388-6393.

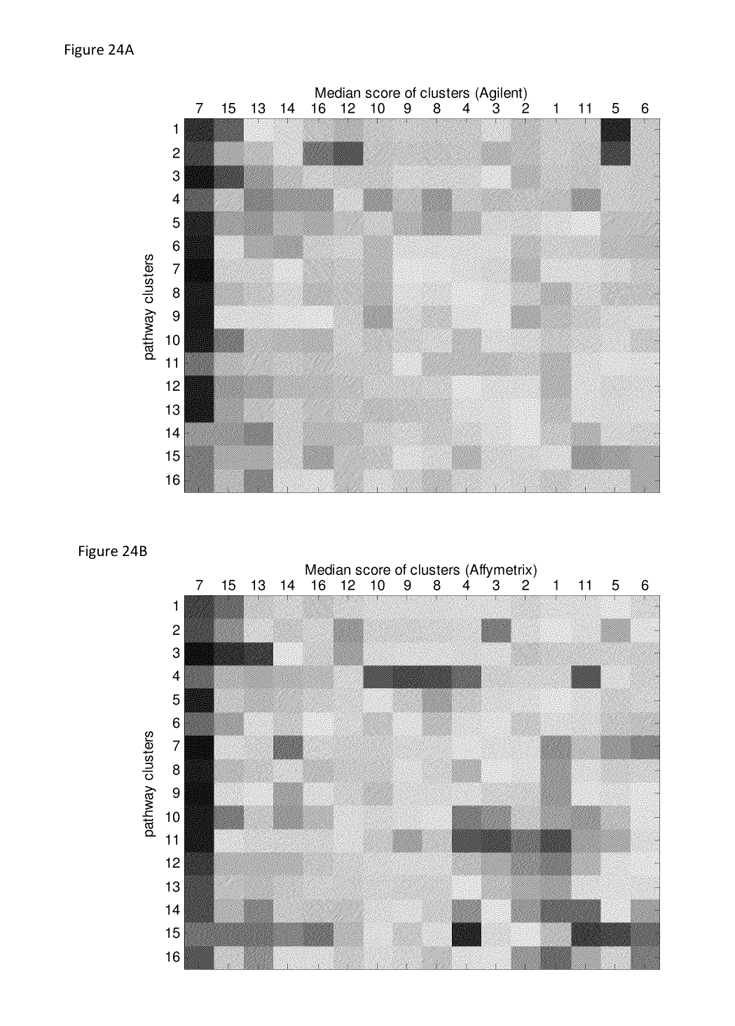

FIGS. 24A and 24B present a summary of clustered PDS for Agilent (FIG. 24A) and Affymetrix (FIG. 24B) shown in the same order of clusters as in FIG. 2B in the above PNAS paper.

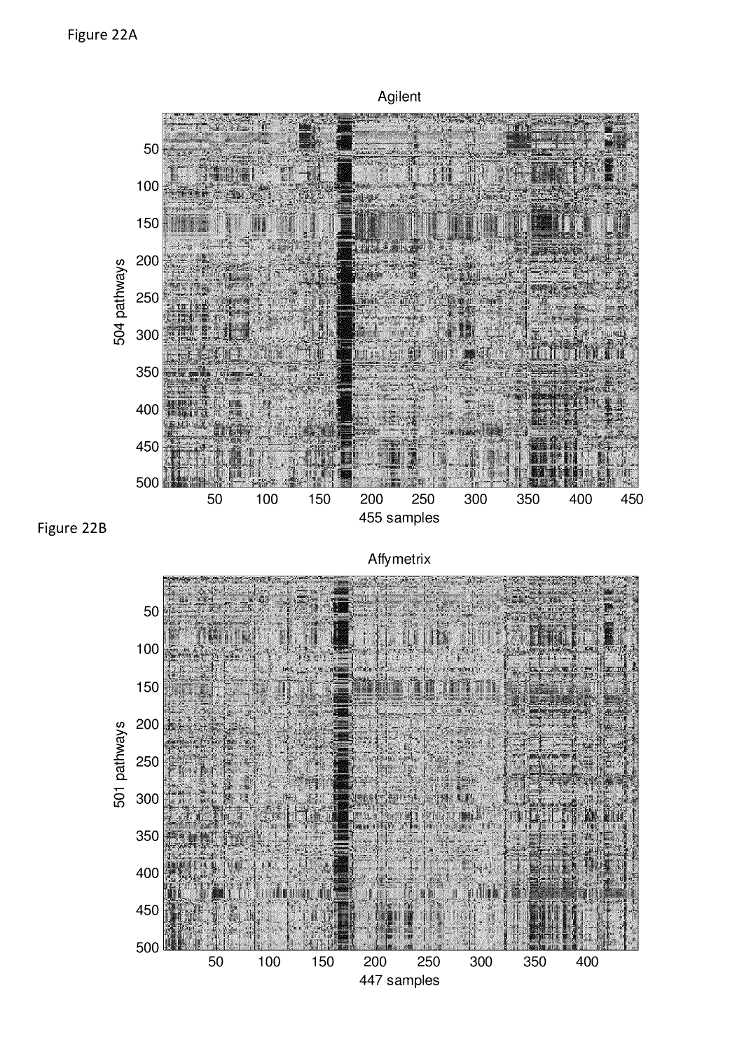

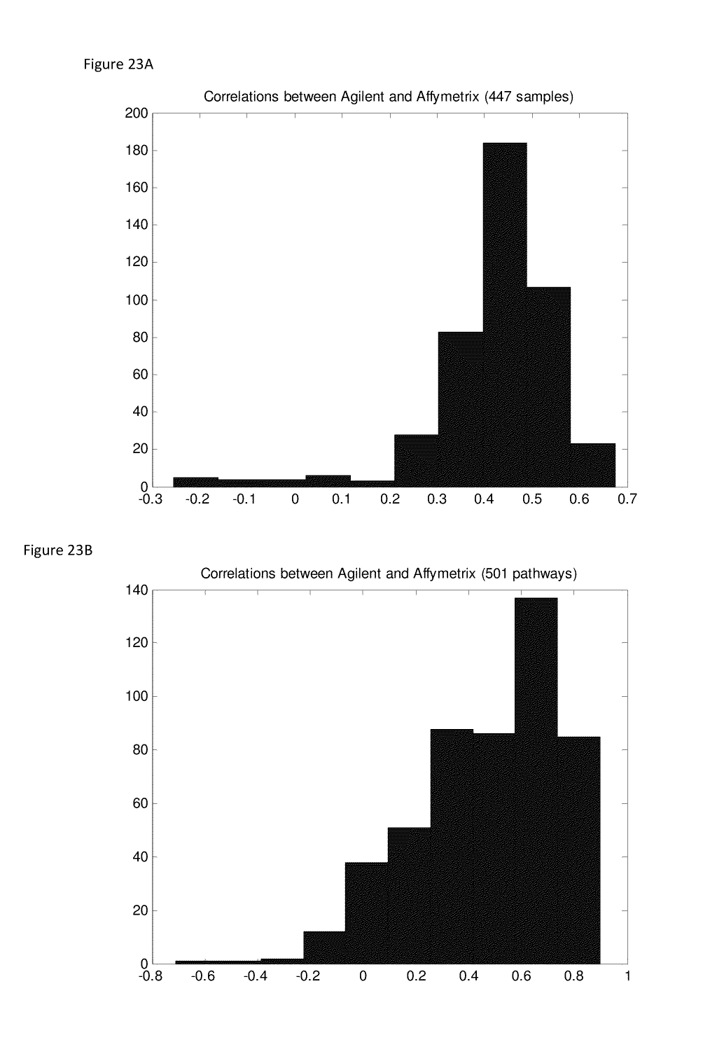

In order to compare the results between the two platforms, the Pearson correlation between Agilent and Affymetrix PDS values over all pathways was calculated for every sample. The histogram of the correlation values per sample is shown in FIG. 23A.

Similarly, the Pearson correlation between Agilent and Affymetrix PDS values over all samples was also calculated for every pathway. The histogram of the correlation values per pathway is shown in FIG. 23B.

The results clearly demonstrate that the inventive method is operative, efficient and accurate, regardless of the expression platform used or other experimental conditions which are present.

### Other Embodiments

It is to be understood that while the invention has been described in conjunction with the detailed description thereof, the foregoing description is intended to illustrate and not limit the scope of the invention, which is defined by the scope of the appended claims. Optionally any one or more embodiments, sub-embodiments and/or components of any embodiment may be combined. Also optionally any combination or subcombination of elements or embodiments may optionally be combined. Other aspects, advantages, and modifications are within the scope of the following claims.

What is claimed is:

1. A method for non-linear quantification of pathway deregulation in an individual biological sample for analysis of malignancies, comprising calculating deregulation levels of a plurality of pathways for a particular cancer from a plurality of samples related to said cancer; generating a pathway-level representation of each of said plurality of samples; characterizing tumor behavior according to said pathway-level representation, including said deregulation levels, wherein said biological sample is a single tumor or malignancy and with the proviso that no detailed knowledge of the network or mechanism of the pathway activity is needed; and determining a clinically relevant representation of said biological sample according to said characterizing said tumor behavior.

2. The method of claim 1, wherein said calculating said deregulation levels further comprises determining said pathway deregulation by inferring pathway deregulation scores for each tumor sample on the basis of expression data.

3. The method of claim 2, wherein said inferring pathway deregulation scores is performed for a plurality of data sets and tumor samples.

4. The method of claim 3, wherein said inferring pathway deregulation scores transforms gene level information into pathway level information, thereby generating a compact and biologically relevant representation of each sample.

5. The method of claim 4, wherein said cancer is selected from the group consisting of glioblastoma and colon cancer.

6. The method of claim 5, further comprising determining specific pathways that are demonstrated to be significantly associated with survival of glioblastoma patients.

7. The method of claim 6, further comprising determining a sub-class of Proneural and Neural glioblastoma that are associated with significantly better survival of a patient.

8. The method of claim 4, further comprising determining CXCR3-mediated signaling and oxidative phosphorylation scores for colorectal cancer in a patient, and predicting survival of the patient according to said scores.

9. The method of claim 8, further comprising determining a new class of EGFR-deregulated colon cancers.

10. The method of claim 4, wherein said calculating deregulation levels of said plurality of pathways further comprises selecting a plurality of biological pathways P for a malignancy; for each pathway P, identifying d_{P} genes that belong to it; determining expression values for each of said d_{P} genes for each pathway P, wherein each sample i of a plurality of samples is represented by a point Xᵢ of the expression values of said genes, said plurality of samples comprising malignant and normal tissue samples; calculating a Principal Curve of the cloud of points formed by the full sample set of the expression values of said genes for each pathway P; projecting every point onto said Principal Curve and denoting by Yᵢ the projection of X, onto said curve; determining pathway deregulation according to said Principal Curve for each pathway P; and determining said deregulation levels of said plurality of pathways after said determining pathway deregulation according to said Principal Curve for each pathway.

11. The method of claim 10, further comprising determining, for each pathway P, the center of mass of the points that represent all the available normal tissue samples; and determining quantification of pathway deregulation for each individual malignant sample by comparing said center of mass of the normal tissue to said point representing every one of the malignant samples.

12. The method of claim 11, wherein said comparing said center of mass of the normal tissue to said malignant sample comprises calculating said center of mass of the normal tissue, its projection, N, onto said Principal Curve of the cloud of points formed by the full sample set of the expression values of said genes, projecting every point Xᵢ onto said Principal Curve, for each of the normal and malignant samples; determining the distance of the projection, Yᵢ from N, measured along the principal curve, wherein said distance is Dᵢ (P), the Deregulation Score of pathway P in sample i; and determining for every sample of said plurality of samples a plurality of deregulation scores for said plurality of pathways P.

13. The method of claim 12, further comprising clustering, on the basis of said plurality of deregulation scores, the said plurality of samples and said plurality of pathways P.

14. The method of claim 13, further comprising determining a class or subclass for said malignancy according to said clustering of the samples.

15. A method for non-linear quantification of pathway deregulation for analysis of a single individual malignancy, comprising selecting a plurality of biological pathways P for a malignancy; for each pathway P, identifying d_{P} genes that belong to it; determining expression values for each of said d_{P} genes, wherein each sample i of a plurality of samples is represented by a point X, of the expression values of said genes, said plurality of samples comprising malignant and normal tissue samples; calculating a Principal Curve of the cloud of points formed by the full sample set of the expression values of said genes, projecting every point onto said Principal Curve, denoting by Yᵢ the projection of Xᵢ onto said curve; and determining pathway deregulation according to said Principal Curve.

16. The method of claim 15, further comprising determining, for each pathway P, the center of mass of the points that represent all the available normal tissue samples; and determining quantification of pathway deregulation for each individual malignant sample by comparing said center of mass of the normal tissue to said point representing every one of the malignant samples.

17. The method of claim 16, wherein said comparing said center of mass of the normal tissue to said malignant sample comprises calculating said center of mass of the normal tissue, its projection, N, onto said Principal Curve of the cloud of points formed by the full sample set of the expression values of said genes, projecting every point Xᵢ onto said Principal Curve, for each of the normal and malignant samples; determining the distance of the projection, Yᵢ from N, measured along the principal curve, wherein said distance is Dᵢ (P), the Deregulation Score of pathway P in sample i; and determining for every sample of said plurality of samples a plurality of deregulation scores for said plurality of pathways P.

18. The method of claim 17, further comprising clustering, on the basis of said plurality of deregulation scores, the said plurality of samples and said plurality of pathways P.

19. The method of claim 18, further comprising determining a class or subclass for said malignancy according to said clustering of the samples.
